(19) United States
(12) Patent Application Publication
(10) Pub. No.: US 2016/0191365 A1
(43) Pub. Date: Jun. 30, 2016

(54) DATA CENTER MIGRATION TRACKING TOOL

(71) Applicant: SingleHop, LLC, Chicago, IL (US)

(72) Inventors: Roger M. Wakeman, Chicago, IL (US); Elizabeth A. Volini, Oak Park, IL (US); Jordan M. Jacobs, Chicago, IL (US); Ricardo Talavera, Burbank, IL (US); Andrew W. Pace, Chicago, IL (US); Lukasz Tworek, Dublin, OH (US); Michael A. Davis, Phoenix, AZ (US); Austin T. Wilson, Oxford, CT (US)

(73) Assignee: SINGLEHOP, LLC, Chicago, IL (US)

(21) Appl. No.: 14/826,802

(22) Filed: Aug. 14, 2015

Related U.S. Application Data
(60) Provisional application No. 62/098,970, filed on Dec. 31, 2014.

(51) Int. Cl. H04L 12/26; H04L 12/24

(52) U.S. Cl. CPC H04L 43/10; H04L 41/12

(57) ABSTRACT

A system stored in a non-transitory medium executable by processor circuitry for tracking the migration of a plurality of servers between data centers is provided. In one embodiment, the system comprising a job scheduler tool that receives a list of migrating devices that are migrating from an origin data center to a destination data center. A migration database stores migration data for each migrating device, the migration data including information representing a current migration state and past migration states of each migrating device. One or more processors execute migration logic to identify destination information in the destination data center for each migrating device in the list of devices, and an analyze tool checks the current migration state of each migrating device and identifies errors during migration of each migrating device to the destination data center.

### CROSS REFERENCE TO RELATED APPLICATIONS

This application is a continuation of and claims priority to U.S. Provisional Application Ser. No. 62/098,970, filed Dec. 31, 2014, which is hereby incorporated by reference in its entirety

### BACKGROUND OF THE INVENTION

1. Field of the Invention

The present disclosure relates generally to information technology, and more particularly, to physically relocating servers from an origin Data Center to a new Data Center.

2. Description of the Background of the Invention

Data Centers are physical facilities which generally house a large group of networked computer servers (assets) typically used by organizations for the remote storage, processing, or distribution of large amounts of data.

Hosted Data Centers are typically characterized by particular customers owning or leasing servers at physical Data Center location(s). The customers pay the Data Center owner for supporting and managing the servers at the Data Center and providing enterprise connectivity.

On occasion, a Data Center may need to relocate from an origin Data Center to a new/destination Data Center. Reasons for this are varied, and for example, may include finding a cheaper lease at a new location and/or other desirable features at such new location (e.g., closer proximity to a main office, better network connectivity, and/or improved service level agreements). In order to move the Data Center assets to the new location, the Data Center needs to shut down the customer servers in a controlled fashion including tracking and copying network connectivity, load them onto a truck for transport to the new Data Center, and finally install the servers at the new Data Center, making sure throughout that each asset (e.g., servers or firewalls) is tracked and operating properly in accordance with each asset's particular needs and to minimize server downtime to each asset.

A key concern in migrating the servers to the new Data Center is minimizing downtime for each customer server. For example, particular customers need their servers operational in order to effectively sell goods on their online ecommerce platforms and/or other customers may be hosting critical business systems. Data Center Operators may also have significant contractual Service Level Agreements that require financial penalties payable to their customers for extended downtime. For a particular Data Center customer, a shut down for even a brief period of less than an hour can potentially result in thousands of dollars of lost revenue and/or other negative consequences.

Another potential problem in moving servers is the possibility of data loss caused by manually shutting down all servers prior to transport, and/or network issues that would prevent the servers from being brought back online into production use at the destination Data Center.

### SUMMARY OF INVENTION

The present disclosure contemplates, in one or more embodiments, a pre-migration tool that performs analysis prior to migrating servers, and reduces risk by proactively highlighting known issues and providing the ability to mitigate them prior to migration to reduce downtime.

In one embodiment, the present disclosure contemplates a migration tool that tracks the status of all customer servers for one or more stages of a Data Center migration, resulting in substantially less downtime than using conventional methods and also resulting in a lower frequency of errors.

In one or more additional embodiments, the present disclosure contemplates a migration tool that allows for the monitoring and tracking of customer servers for one or more stages of the Data Center migration, resulting in substantially less downtime than using conventional methods, due to substantially reducing time to resolve errors provided by the ability to monitor and communicate internally around the status of servers and issues.

In one or more additional embodiments, the present disclosure contemplates a remote shut down feature that facilitates shutdown of one or more servers to reduce the risk of data loss.

In one or more additional embodiments, the present disclosure contemplates a convenient mechanism for communicating server migration status to customers, including details such as commencement time of shutting down a customer server and also elapsed time between shut down and successful installation at the new Data Center.

In one or more additional embodiments, the present disclosure contemplates a convenient mechanism for instantly identifying any misplaced servers that have been misplaced at the wrong location at the new Data Center. This may afford a tremendous time savings for workers and obviate the need to physically, and perhaps repeatedly, inventory all servers and their locations and look for any discrepancies from an initial planning spreadsheet.

In one or more additional embodiments, the present disclosure contemplates in one or more embodiments a convenient mechanism for storing the configuration (e.g., IP address and other attributes) of each server prior to transport and then immediately applying the stored configuration to the server once installed at the new Data Center. This affords the advantage of very quickly and efficiently recreating the same set up at the new Data Center with minimal downtime.

Another advantage of the tracking features shown in one or more embodiments is that workers can prioritize which tasks to perform immediately and which tasks can be pushed back to later in the migration process.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles involved and to enable a person skilled in the relevant art(s) to make and use the disclosed technologies.

FIG. 1A is an exemplary diagram depicting an overview of a server migration from an origin Data Center to a destination Data Center according to certain embodiments;

FIG. 1B is an exemplary process diagram depicting a migration preparation progress, an overview of a Migration Job Scheduler and an overview of possible migration statuses according to certain embodiments;

FIG. 1C is an exemplary process diagram depicting the process used to check out a server or device being migrated which is used by the Migration Job Scheduler 22 according to certain embodiments;

FIG. 1D is an exemplary process diagram depicting the process initiated by a Migration Tool Operator 18 when starting migrations according to certain embodiments;

FIG. 1E is an exemplary process diagram depicting the logic for servers in the started or assessing statuses according to certain embodiments;

FIG. 1F is an exemplary process diagram depicting the logic for servers in the shutting off status according to certain embodiments;

FIG. 1G is an exemplary process diagram depicting the logic for servers being manually discovered through the migration tool interface, and logic for acting on a MAC (Media Access Control) address change notification according to certain embodiments;

FIG. 1H is an exemplary process diagram depicting the logic for servers in discovered, network applied and network failed status according to certain embodiments;

FIGS. 2A-B are screen shots depicting an exemplary interface for implementing an analyze server action according to certain embodiments;

FIG. 3 is a screen shot depicting an exemplary interface of an error log generated from the analyze server action according to certain embodiments;

FIG. 4 is a screen shot depicting an exemplary interface for implementing a controlled reboot tool according to certain embodiments;

FIG. 5 is a screen shot depicting an exemplary interface for a migrate servers action according to certain embodiments;

FIG. 6A is a screen shot depicting an exemplary interface displaying server information for servers that have failed to shut off according to certain embodiments;

FIGS. 6B1-B2 are a screen shot depicting an exemplary interface displaying server information for a particular move group according to certain embodiments;

FIG. 6C is an enlarged screen shot depicting an exemplary interface for displaying the types of fields illustrated in FIGS. 6A and 6B for a particular server according to certain embodiments;

FIG. 6D is a screen shot depicting an exemplary interface for displaying a migration log for a particular server according to certain embodiments;

FIG. 7 is a screen shot depicting an exemplary interface for displaying migration status meters for a particular point in time during a migration according to certain embodiments;

FIG. 8 is a screen shot depicting an exemplary interface for displaying migration status meters and also depicting an additional network failed meter that may appear at a point during migration process in which one or more servers have failed to connect according to certain embodiments;

FIG. 9 is a screen shot depicting an exemplary interface for displaying a general migration log according to certain embodiments;

FIG. 10 is a screen shot depicting an exemplary interface for displaying migration status according to certain embodiments;

FIG. 11 is a screen shot depicting an exemplary interface for displaying a log of servers designated as in transit at a particular point in time during a data center migration according to certain embodiments; and

FIGS. 12-22B are a set of related screen shots depicting exemplary interfaces for displaying various aspects of the server migration process and taken during a particular points in time throughout the process according to certain embodiments.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrases “in another embodiment” or “in further embodiments” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

By way of introduction, a system is described herein that monitors, troubleshoots, and tracks the physical migration of a plurality of devices between data centers. The devices may include servers or electronic devices. In one aspect, the system tracks and maintains a list of migrating devices that are migrating from an origin data center to a destination data center. The system stores migration data for each migrating device that includes information on all aspects of the migration, including, but not limited to, the current migration state of the device, past migration states, and information related to the past states that identifies the nature of the state and any event that took place during migration of the device. In some embodiments, the system utilizes migration and automation logic to identify servers that are being shut down for migration, tracks those servers during transition to the new data center, identifies any errors during transition of the server, recognizes when the servers have been installed in the new data center, and automatically configures the servers in the new data center for operation, including networking and operation parameters. Aspects of the present description therefore provide for the seamless migration of servers and other devices, while also allowing users to monitor the migration and troubleshoot any migration issues with specific servers. As described further herein and illustrated in the figures, the system also implements a number of interfaces that depict information on each stage of the migration to provide status as well as troubleshooting information as well as provide interactive interface elements that allow the users to, for example, input information manually identifying the server and destination location in the new data center, as well as other information when the system identifies any errors during migration. This introduction is merely exemplary of the features and operations of the present description and a number of features of operations will not be described with reference to the figures and in greater detail herein.

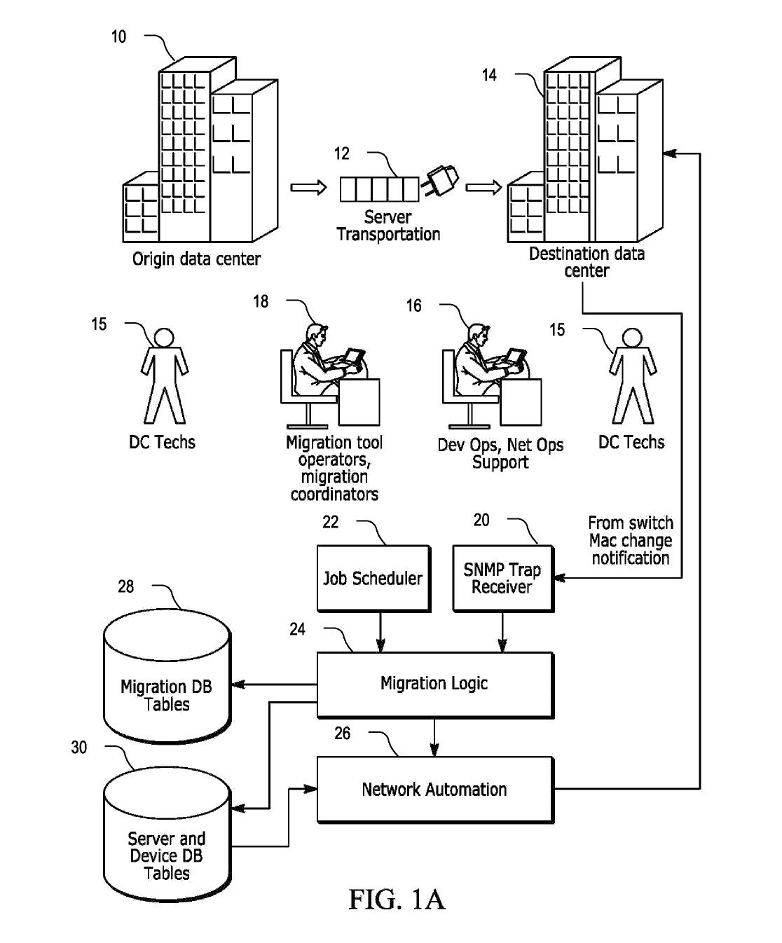

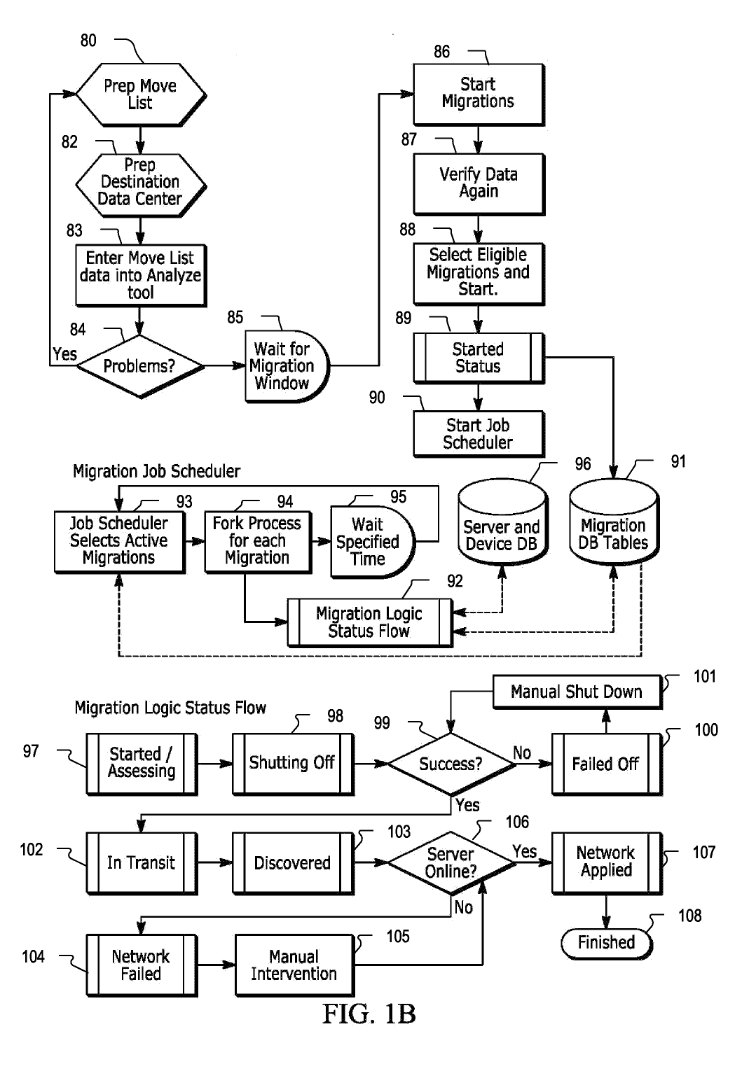

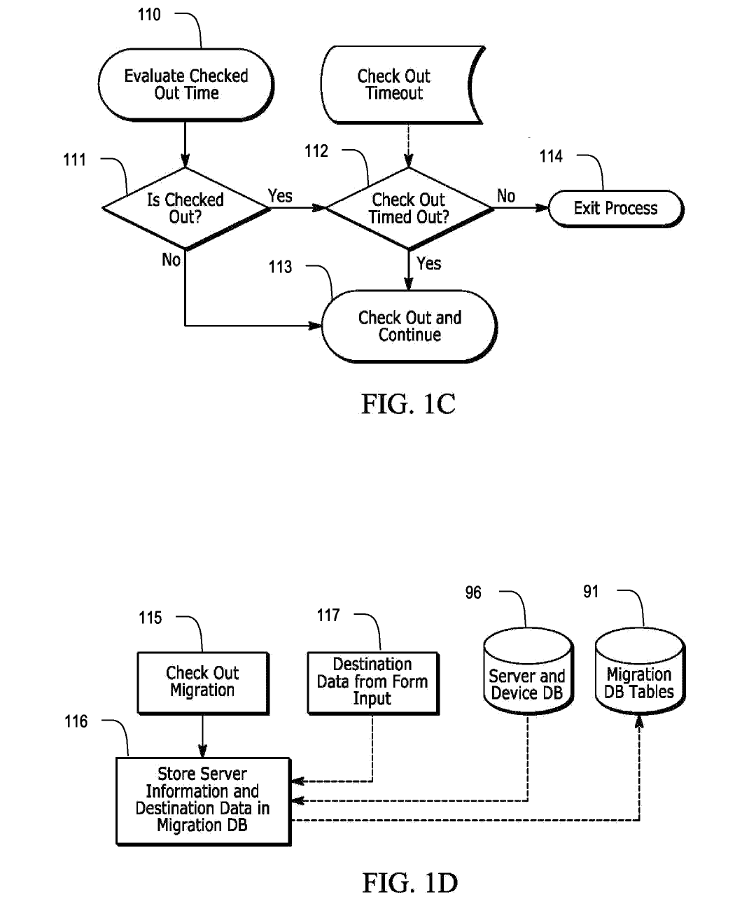

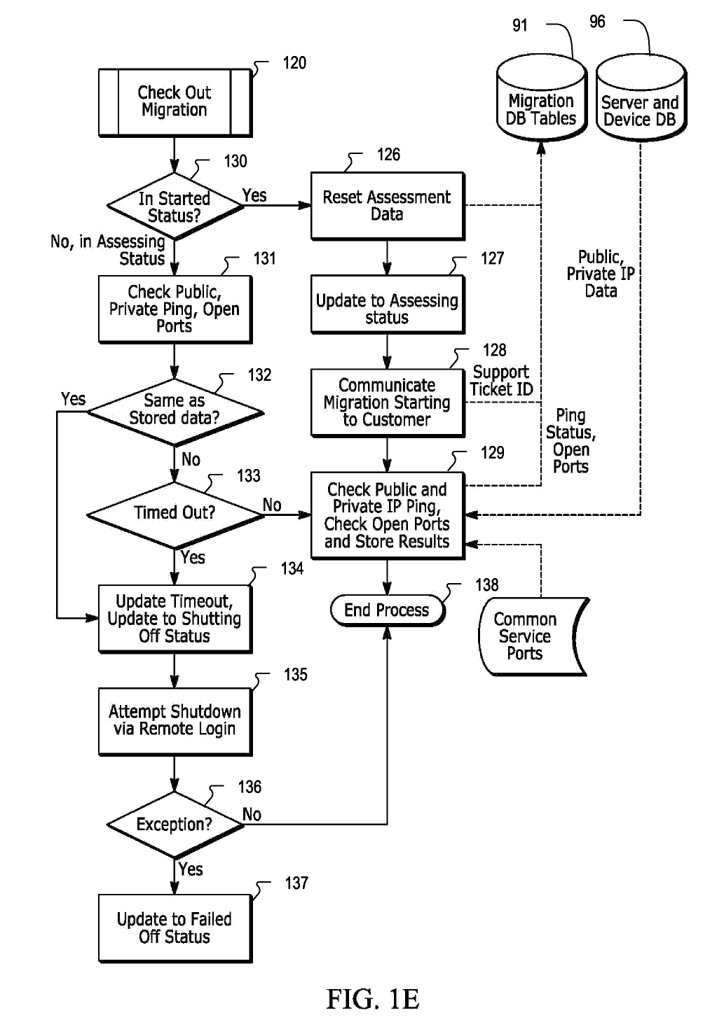

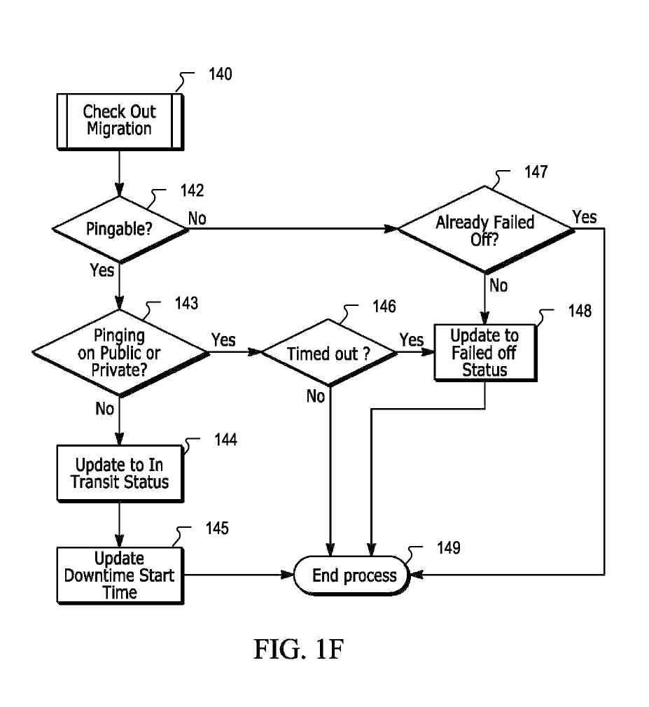

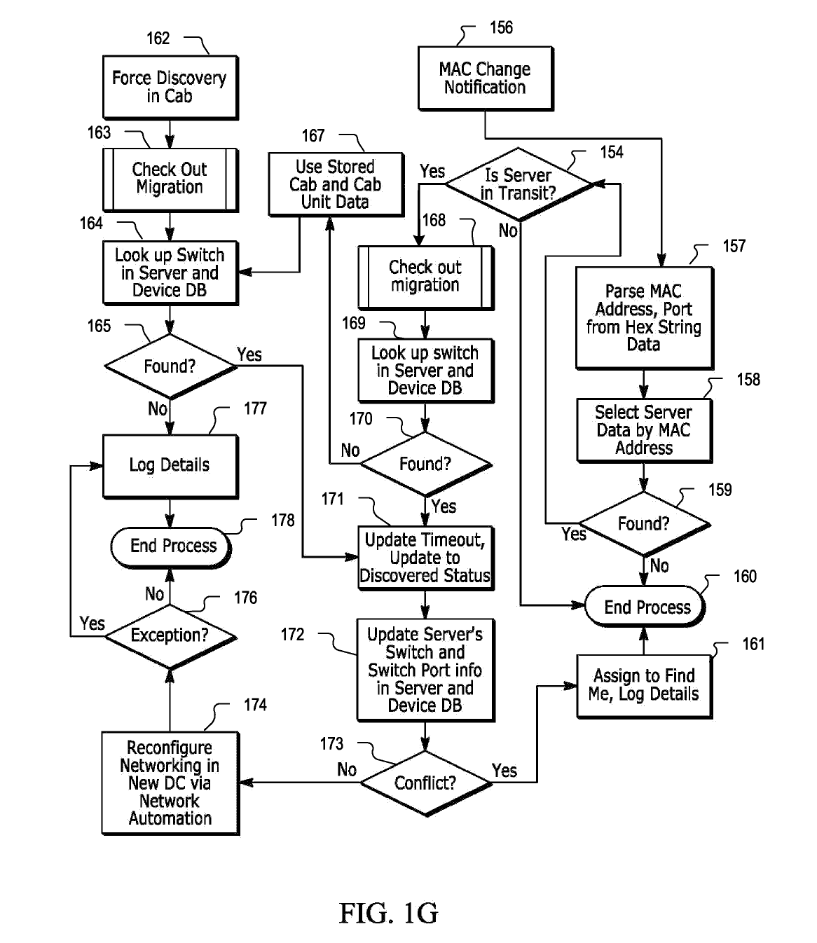

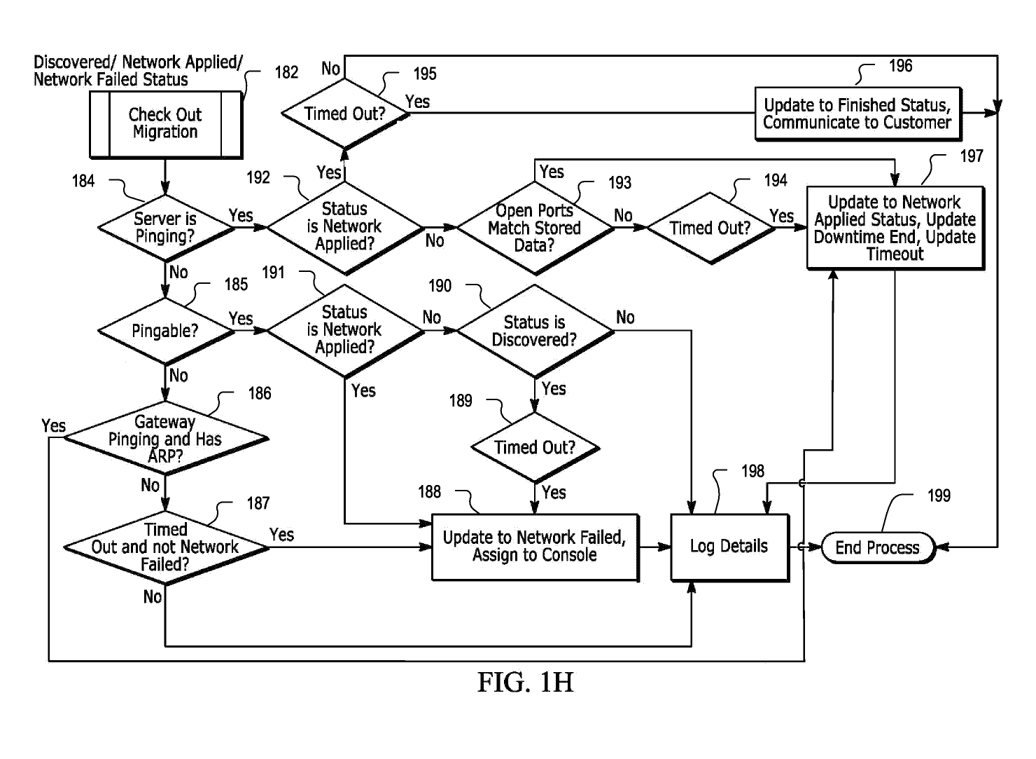

Referring now to the figures, FIGS. 1A-1H show a general diagram and flow process that may be used for server migration from an origin Data Center 10 to a new Data Center (i.e., destination Data Center 14) according to various embodiments. The servers may be transported by any suitable vehicle 12 such as a truck. Technicians/workers 15 are located at both the origin and destination Data Centers 10 for disconnecting and connecting servers, respectively. One or more migration tool operators 18 may operate the below described migration tool to track the status of servers and to assign particular workers to particular server issues requiring attention. Also, technical 16 (e.g. network or development or Data Center operations) personnel may be available to supervise the migration and/or troubleshoot networking or other issues affecting the migration.

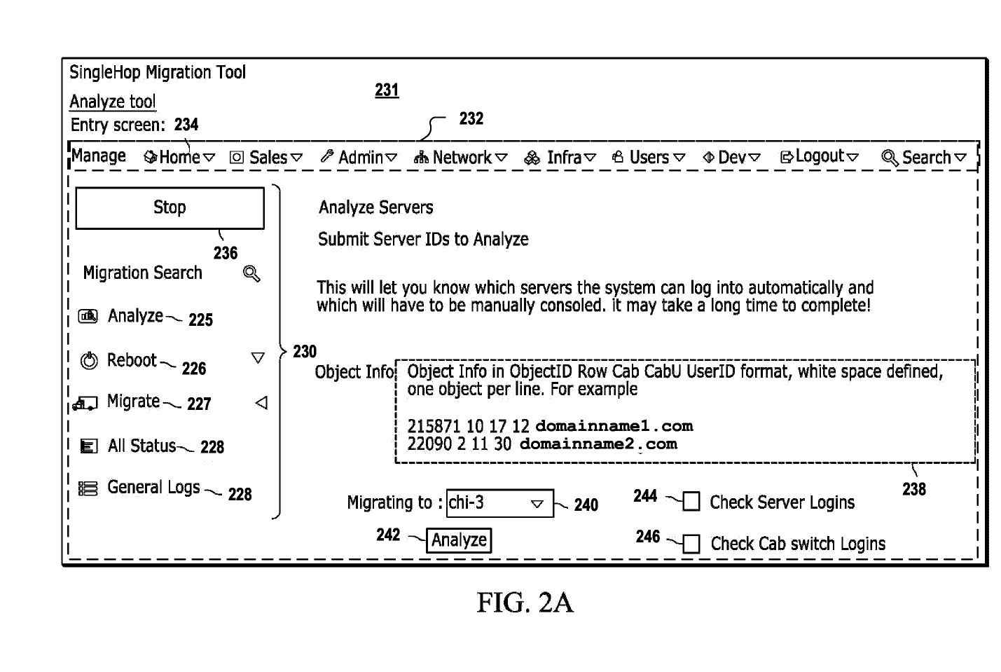

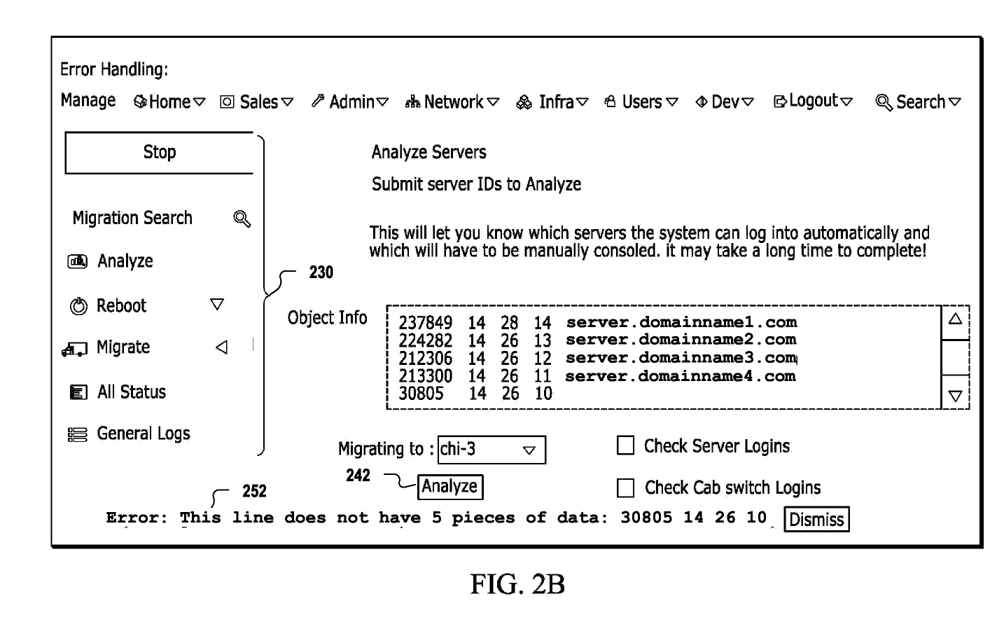

Referring to FIG. 1A, the Job Scheduler 22 is a system for periodically checking active migrations and routing them to the appropriate Migration Logic 24 based on their current status. In some embodiments, Job Scheduler 22 can be initiated, stopped, or otherwise turned on and off using the Migration Tool “Start/Stop” button 236, such as depicted and described in connection with FIG. 2B, for example.

The Migration Logic 24 is comprised of programmed logic for evaluating individual migrations and attempting to move them from their current status to the next status, such as may be associated with the destination Data Center 14.

The SNMP Trap Receiver 20 is a server that is configured to receive MAC address Change Notification traps in the Simple Network Management Protocol from configured switches in the Destination Data Center 14. When a migrating server is plugged into a switch in the Destination Data Center 14 and turned on, the switch sends encoded information to the SNMP Trap Receiver containing the discovered MAC address of the server's Ethernet Network Interface Controller (NIC), along with the associated physical switch port for which it is connected to, sourced from the switch IP address. Using that information, the Migration Logic 24 determines the server's new destination cabinet, cab unit, switched power distribution unit (PDU) ports, and switch ports for public and private network interfaces if applicable. In some embodiments, the SNMP Trap Receiver 20 may be located in a separate server from the Job Scheduler 22 and Migration Logic 24 for security reasons.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like

Migration DB Tables 28 hold data on every migration including identifiers linking the migration to the Server and Device DB Tables 30, human readable identifiers like host names, current migration status, logs for every step of the migration process, server connectivity information as evaluated at the start of the migration, the intended destination for the server in the Destination Data Center 14, Origin Data Center 10, the migration's move group, down time start, down time end, and customer support ticket information.

The Server and Device DB Tables 30 contain information about all servers and devices being migrated as well as their location and networking setups in the Origin Data Center 10 and Destination Data Center 14. These are used by Network Automation 26 to migrate the networking settings from the Origin Data Center 10 to the Destination Data Center 14.

Network Automation 26 reads the Server and Device DB for each server that has been discovered in the Destination Data Center 14 and transfers its networking configuration from the Origin Data Center 10, creating an identical networking setup in the Destination Data Center 14.

Referring now to FIGS. 1B-1H, an exemplary flow process for the data center migration tool is illustrated according to certain embodiments, including the logical operation that may be performed by migration technicians prepping and starting a migration (starting at block 80), the Migration Job Scheduler 22 (starting at block 93) and by the Migration Logic 24 (starting at block 97). The logical operations may be carried out by one or more hardware devices (such as one or more circuits and/or microprocessors working individually or in combination), firmware, software, or any combination thereof, which may be controlled, for example, by a CPU, logic stored memory, or a system stored on a non-transitory storage medium having instructions stored thereon to execute each of the functions described in connection with each operation. In some embodiments, logical operations may be implemented by one or more servers, which may be distributed servers in operative communication over a network, and/or corresponding software, firmware, or hardware on each of those servers. For example, each operation may be associated with a dedicated tool that comprises one or more dedicated circuits, a programmable logic arrays (PLA), application-specific integrated circuits (ASIC), one or more programmed microprocessors and/or software controlled microprocessors, discrete logic, a programmable/programmed logic device, or memory device containing instructions.

Referring back to FIG. 1B, an exemplary process diagram depicting a migration preparation progress, an overview of a Migration Job Scheduler and an overview of possible migration statuses according to certain embodiments is shown. At block 80, the move list for data center migration is prepared. For example, the system and/or system operators choose servers and devices to migrate in this portion of the process and select locations in the Destination Data Center 14 to relocate the servers and devices. At block 82, the Destination Data Center 14 is prepared so that it may receive the migrating devices and servers. The system, and/or system operators, sets up destination server cabinets and networking in the Destination Data Center 14. In block 83, the move list data is entered into an analyze tool to check for recognizable problems in the data. At block 84, if problems are recognized the process returns to block 80. If no problems are recognized at block 84, the system proceeds to block 85 where the system waits for a migration window or time period that the services and devices may be migrated to the Destination Data Center 14. At block 86, when the migration window is open, the system begins migration by entering the Server ID, Cabinet, and Cab Unit Data in the Destination Data Center 14 for each server and device that is being migrated to Destination Data Center 14. At block 87, the system verifies the data again, such as by using the analyze tool described in connection with block 83 (as well as with analyze button 242 described further in connection with FIG. 2), to ensure that the server information in Destination Data Center 14 has not changed. At block 88, the system selects the eligible migrations and beings the migration process. At block 89, the migration status is updated to “started” status. At block 90, the start job scheduler initiates and operates as described further in connection blocks 93, 94, and 95.

At block 91, the Migration DB Tables 28 are updated to reflect the status of the migration for the servers and devices. In particular, the system may store identifiers linking the migration to the Server and Device DB Tables 30, human readable identifiers like host names, current migration status, logs for every step of the migration process, server connectivity information as evaluated at the start of the migration, the intended destination for the server in the Destination Data Center 14, Origin Data Center 10, the migration's move group, down time start, down time end, and customer support ticket information. At block 92, Migration Logic 24 evaluates the migrations for the individual servers and devices for moving them from their current status to the next status. Migration Logic 24 determines the server's new destination cabinet, cab unit, switch ports for public and private network interfaces if applicable. At block 93, the Migration Job Scheduler 22 selects active migrations and at block 94, the process for each migration is forked and processed by the system, such as individually or concurrently using one or more parallel processors. At block 95, the system waits a specified time before scheduling new jobs for active migrations that are not currently busy. At block 92, Migration Job Scheduler 22 sends updated migration status information to Migration Database (DB) Tables 91 and Server Device DB 96, which may be the same tables described in connection with FIG. 1A.

At block 97, the migration logic status flow for Migration Logic 24, as described in connection with block 92, is illustrated in further detail. At block 97, the Migration Logic 24 begins assessing the individual migrations and attempts to move them from their current status to the next status. At block 98, the system shuts off particular servers and devices that are ready for migration. At block 99, if the shutdown was not successful the system recognizes the situation as a failed off at block 100 and proceeds to block 101 where it requests a manual shut down of the device or server. When the shutdown is a success at block 99, the system updates the database records to show the device and server as in transit at block 102 until the migration is discovered at block 103. At block 106, the system determines whether the server is online. If the server is not online, the system updates the record as network failed at block 104 and flags the migration for manual intervention at block 105. If the server is online at block 106, the system updates the record to “network applied” at block 107 and the system finishes the successful migration at block 108.

Referring now to FIG. 1C, an exemplary process diagram depicting the process used to check out a server or device being migrated which is used by the Migration Job Scheduler 22 according to certain embodiments is shown. In certain applications, the migration or task being completed on a server may take significant processing time. In order to prevent the same server or device from being operated on by potentially conflicting processes, the migration automation logic may “check out” the device and monitor it so as to ensure that the Job Schedule does not schedule an additional process while a current action is currently processing. In some embodiments, the system may issue periodic checks to the device to ensure that the action has not failed and the operation has not timed out. At block 110, the checked out time for a server or device that is being migrated is evaluated. At block 111, the system determines whether the server or devices is checked out or otherwise unavailable, which may indicate that the server is being currently being processed according to one of the migration logic steps. If the determination result is negative, the system proceeds to block 113 and checks out the server or device to indicate that it is unavailable to other processes. If the determination result is affirmative, the system evaluates the checked out time for the server or device to determine whether the device or server has timed out at block 112. The checked out time threshold represents the amount of time that must pass before a migration that has “checked out” status may be considered “timed out.” If a prior migration has “timed out,” then server can be made available to be checked out by the current process. The system may receive a standard or default checked out time threshold that is used for all evaluations or a system administrator may specify a checked out time threshold value for a specific migration project or a checked out time threshold may be set by the Migration Logic 24 based on the current status of the migrating server or device. In other embodiments, the system may determine a checked out time threshold value, such as by utilizing statistical computation methods to evaluate prior migrations and determine average or representative time period that accurately indicates a process using a server or device has timed out. If the server or device has not timed out, the system exits at block 114. If the server or device has timed out, then the system may then check out the device or server at block 113.

Referring now to FIG. 1D, an exemplary process for starting a migration is illustrated in further detail, such as that may be used during block 89 and/or initiated by a Migration Tool Operator 18 when starting migrations according to certain embodiments. At block 115, the device or server is checked out for processing. At block 116, the system stores the server information and destination data in a migration database, such as in Migration DB Tables 28, described in connection with FIG. 1A. At block 117, the system also receives destination data from one or more inputs and retrieves corresponding information from Server and Device DBs 96. At block 91, the Migration DB Tables 91 are updated.

Referring now to FIG. 1E, an exemplary process diagram depicting the logic for the automated system to start the migration progress and identify servers in the Started or Assessing status 97 is illustrated. At block 120, the check out migration process begins. At block 130, the system determines whether migration status indicates that migration has started. If the determination at block 130 is no, the system proceeds to block 131, where the system checks public and private ping on its IP which verifies whether its networking is configured and active, and checks open ports. At block 132, the system determines whether the public and private ping and open ports are the same as the store data. If the determination at block 132 is affirmative, the system proceeds to block 134 where it updates the timeout indication, and updates to shutting office status. The system then attempts shutdown via a remote login at block 135 and if there are no exceptions thrown at 136, the process ends at 138. If an exception is thrown at 136, the system updates the status to failed off at block 137. If the data is not the same as the stored data at block 132 and the system has not timed out at block 133, then the system checks if the public and private IP pings, checks the open ports, and stores the result in the databases at block 129 and the process ends at block 138.

If, at block 130, the status of the migration was set to started, then the system proceeds to block 126 where the assessment data is reset and the migration DB tables 91 are updated. At block 127, the migration status is updated to assessing status and the system communicates that the migration is starting to the customer at block 128. At this time, the information for any support tickets is also written to the Migration DB Tables 91. As before, at block 129, the system checks whether the public and private IPs ping, checks the open ports, and stores the result in the Migration DB Tables 91. Also at block 129, the system may receive information about the networking configuration of the server or device from the Server and Device DB 96, such as public and private IP data from the Server and Device DB 96, and attempt to ping those IPs, as may be necessary. The process according to this embodiment ends at block 138.

Referring now to FIG. 1F, an exemplary process diagram depicting the logic for the automated system to handle a migrating server or device in shutting off or failed off status according to some embodiments is illustrated. The process starts at block 140 by checking out the migration according to the check out process starting at 110. At block 142, the system determines whether the server or device is “pingable” indicating that the server is pinging on an IP. This may include both “Public Ping” and “Private Ping,” depending on the circumstances. At block 143, if the server is pinging on its public or private IP addresses, then the system determines whether the migration has timed out at block 146. If migration has not timed out, the sub-process ends at block 149. If the migration has timed out, then the status is updated to failed off at 148. If the server or device is not pinging at block 143, the migration status is updated to in transit and the downtime timer for the migration is started. If the server or device is not pingable at block 142, then the system checks whether the failed off indication or status is present. If so, the process ends at block 149, and if not, the system updates the failed off status to indicate that the server needs to be shutdown and updated to in transit status manually.

Referring now to FIG. 1G, an exemplary process for discovering a server in the Destination Data Center 14 via a migration tool interface, as well as for providing the logic for acting on a MAC address change notification according to certain embodiments, is illustrated. At block 162, a migration tool operator 18 forces discovery of the server, which may cause the system to display a manual input interface to specify the location in the destination data center 14, including the specified cabinet and at the specified rack unit. At block 163, the migration is checked out according to the check out process starting at 110. At block 164, the system looks up the switch corresponding to the provided cabinet data in the Server and Device DB 96. If the switch is not found, the system logs the details at block 177 and ends at block 178. If the switch information is found, the system proceeds to block 171 where it updates the timeout information for migration and updates the migration to discovered status. At block 172, the system updates the server's switch and switch port information in the Server and Device DB 96. The system checks whether there is a conflict at block 173, and if not, the system reconfigures the networking in the new data center using the network automation logic. If there are no exceptions thrown at block 176, the process ends. If there are exceptions, the system logs the details at block 177 and ends. If there is a conflict at block 173, then the system assigns the server to the Find Me function or operation and logs the details before ending at block 160. In some embodiments, the tool provides assignment functionality that assigns a server to a particular technician that is working on the migration. The tool also provides general assignments like Console, Find Me, and Hardware Failure, so as to allow technicians to know what is wrong with the server before assigning it out for troubleshooting. At 161, it has been determined that there is already a server on the switch port that this server is supposed to use, so someone needs to go and find this server in the DC and resolve the conflict. In the event that another server is already assigned to the cabinet and cab unit (as illustrated by the conflict determination at block 173), they both need to be found, verified, and updated by a DC tech 15.

In another related aspect of the check out migration process, illustrated by block 156, whenever the system receives a MAC address change notification through the SNMP Trap Receiver 20—such as may be sent from the primary cab switch when the server is plugged in and turned on, and which may include hex string data specifying the MAC address, switch hostname, and physical switch port, sourced by the switch IP address—the system parses the MAC address and port information from the hex string data in the notification. At block 158, the system selects server data by the MAC address and if the server is found, the system proceeds to block 159. At block 154, if the server is found the system determines whether it is in transit and proceeds to either block 168 or ends at block 160 depending on the determination. At block 168, the migration is checked out and the process may move straight to block 169 and proceed as previously described when the switch information is found. If the information is not found, the system may use the stored cab unit data that was already stored during migration, in which case the system proceeds to block 164. If the server information is not found at block 159, the system ends at block 160.

Referring now to FIG. 1H, the process for handling migrating servers or devices and the providing logic for the automated process to identify servers and devices in discovered, network applied, or network failed status is illustrated. At block 182 migration is checked out according to the check out process starting at 110. At block 184, the system checks whether the server is pinging. If the server is not pinging, the system determines whether it is pingable, which is stored in the assessment data in the migration DB tables 91, for example. If the server or device is not pingable, the system proceeds to block 186, where the system determines if the gateway is pinging and the MAC address of the server has a valid active entry in the switch ARP (Address Resolution Protocol) table (abbreviated as “Has ARP”). If so the system updates the migration to network applied status, updates downtime end, and updates the timeout at block 197, then logs the details at block 198 and ends at block 199. If the gateway is not pinging at block 186, the system determines whether the migration has timed out but there is no network failed indication. If the determination is affirmative, the system updates the migration to networked failed status and assigns it to a console at block 188. At this stage, a DC Tech 15 will likely be required to physically console the machine to verify if there is a networking issue or boot/hardware issue. In either scenario, the details are logged at block 198.

Returning to block 185, the server or device is pingable, the system determines whether the status indicates Network Applied. If so, the system proceeds to block 188 again. If not, the system determines whether the status is discovered at block 190. If the status is not discovered, the details are logged and the process ends. If the status is discovered, the system determines whether the migration has timed out and proceeds to block 188 if so.

Returning to block 184, if the server is pinging, then the system determines whether the status is Network Applied at block 192. If so, the system determines when the server is timed out at block 195. In particular, the system may verify the ping on Network Applied for some time to verify the server is consistently up. If the sever is timed out, the status is updated to Finished Status and the information is communicated to the customer. If the server is not timed out, the process may end at block 199. If the status is not Network Applied at block 192, the system checks whether the data for the open ports matches the stored data at block 193. If so, the system updates the status to Networked Applied, updates the downtime to ended, and updates the timeout information at block 197 before logging the details at block 198 and ending. If the open ports do not match the stored data, they system determines whether the migration has timed out at block 194 and updates the information at block 197 again.

Referring to FIG. 2A, an exemplary interface for implementing an analyze tool for certain embodiments of migration tool 230 is depicted, having main selection actions, including by way of example: an analyze action 225, a reboot action 226, a migrate action 227, an all status action 228, and a general logs action 229. The illustrated screen shot includes an optional outer shell browser 232 for entering or leaving the migration tool 230. For example, a user may click a home icon 234 of the browser 232 to leave the migration tool 230 for the purpose of launching some other application. In some figures, the browser 232 is omitted for ease of illustration.

The migration tool 230 includes a stop button 236 to stop the Job Scheduler 22 from assigning new jobs or processes to be executed on servers and devices. The migration tool 230 also includes an object info field 238 that allows a worker to enter, edit, or paste in origin and destination information for servers or devices being migrated. The tool may also include a destination field 240 that allows a user to select a particular Data Center destination in situations where more than one Data Center destination is possible. When a user clicks an analyze button 242, the tool checks the destination for availability of particular desired ports. The stop button 236 is used to control the Job Scheduler 22. The stop button 236 can be helpful in an emergency situation, for example, if the switches in the Destination Data Center 14 are overloading, the stop button 236 can be employed to stop the Job Scheduler 22, wait for the load to return back to a normal or manageable level, or possibly to push a hotfix for any logic that may have been causing the problem.

Analyze Tool:

The Analyze Tool 231 detects common mistakes in the plan for the next migration. A spreadsheet of data is also provided which includes server ID's, host names and destination cabinet and cab unit information to be verified.

In one embodiment, analyze tool 231 validates that the migration meets the following requirements for each server:
That there is not already another server in the destination cabinet and cab unit.
That there is not another server in the data submitted going to the same destination cabinet and cab unit.
That the server's networking requirements are met by the destination cabinet, such as providing private networking capabilities.
That a server without private networking capabilities is going to a cabinet without private networking capabilities.
That the host name stored in the Server and Device DB is the same as the data entered. If not, the server has been rented to a different customer since the original data was extracted from the Server and Device DB for the migration. In this case new communications may need to be started with the customer and the server may need to be moved to a different migration window.

In addition, analyze tool 231 validates the following requirements for each cab associated with the migration:
That the cabinet's general information is present in the Server and Device DB.
That the cabinet has a primary public switch entered in the Server and Device DB.
That the primary public switch is connected to an aggregation switch according to the Server and Device DB.
That the primary public switch is pinging on its IP, ensuring that its networking is properly configured.
That the cabinet has two APC devices according to the Server and Device DB.

Referring still to FIG. 2A, a second optional step in some embodiments is checking server logins with a “check server logins” option 244 that may be clicked or otherwise selected by the user of the interface. When the analyze button 242 is selected, if the check server logins box 244 is checked, the migration tool 230 will check whether the customer password is available in the event that the customer has provided the Data Center with the password. This facilitates the migration tool 230 executing a safe shut down for particular servers, rather than a manual hard shut down, in order to reduce the risk of data loss from a hard shut down. The interface also includes a check logins 244 selectable element that uses the root/Administrator password stored in the Server and Device DB 30 to attempt to log into all servers entered into the Analyze Tool 231. In one aspect, the tool will show how many servers can be remotely accessed by the Migration Tool using migration logic 24 and how many cannot be remotely accessed. This helps the migration organizers understand how many servers will need to be manually shut down by DC Techs 15 at the Origin Data Center 10, adding time to the migration window. Automatic shut downs performed by the Migration Logic 24 reduce the risk of data loss that is possible with hard shutdowns.

A check cab switch logins 246 checks the networking setup, checking whether the network on the particular cabinet number is active. In one aspect, the primary public switch (cabinet switch) is checked for ping on its IP which verifies whether its networking is configured and active in the Destination Data Center 14

FIG. 2B illustrates an exemplary interface for error handling that is also implemented by the system during analyze action. If there is an error in the data input, such as a missing host name, the migration tool 230 provides an error message 252, allowing the user to go back and fix the error and then click the analyze icon 242 again. Given that the migration tool 230 is in communication with the network and the Server and Devices DB 30 which stores physical space locations in the new Data Center 14, the analyze action is able to determine which ports and destinations are available and which are not.

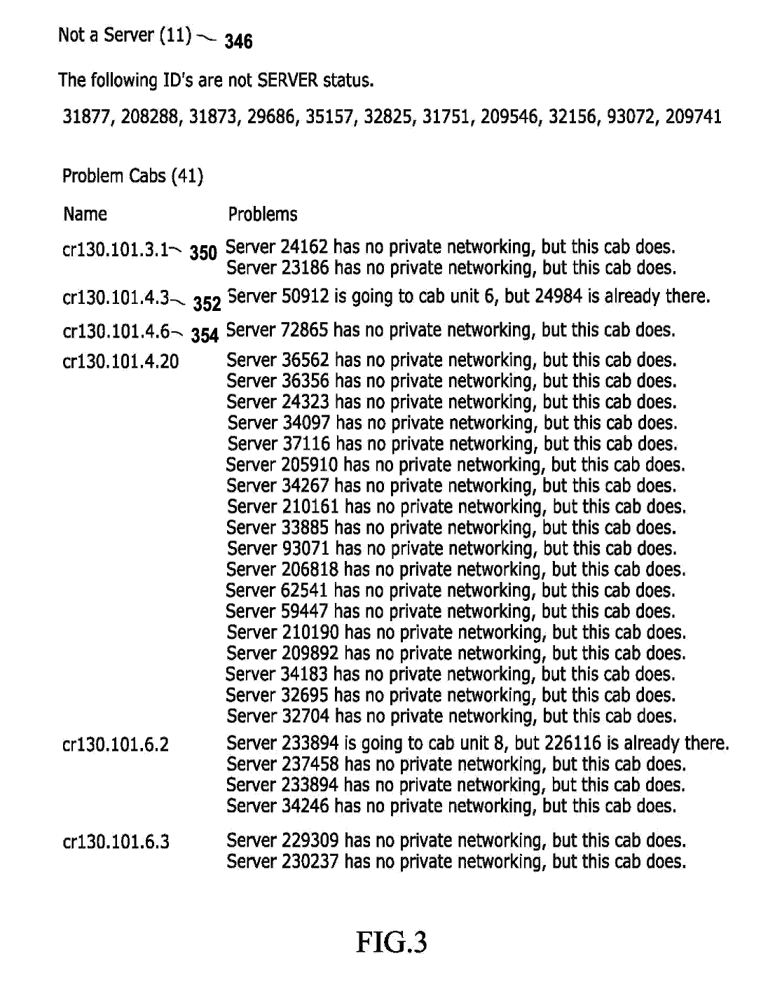

FIG. 3 shows a screen shot depicting an exemplary interface of an error log generated from the analyze server action according to certain embodiments, such as upon clicking of analyze button 242. A “not a server” field 346 shows any servers that have been cancelled by customers. The illustrated servers in this field are not currently being rented by customers and do not need to be moved to the new Data Center or at least do not have any pressing need to be installed at the new Data Center.

FIG. 3 also shows exemplary interface for displaying a log of destination cabinets having problems prior to migration. For each cabinet 350, 352, 354, etc., corresponding messages are displayed as textual string representations informing the user of any problems associated with the particular cabinet. These results may be displayed as result of the analyze tool described in connection with FIGS. 2A-2B, for example. In this exemplary embodiment, a first problem cabinet 350 is identified by a suitable physical location destination code such as the illustrated “cr130.101.3.1,” which translates to computer room 130, cage 101, row 3, rack 1. The first indicated problem for cabinet 350 is that the servers to be placed in cabinet 350 have no private networking but the cabinet 350 has private networking capability. This indicates a waste of space as it would be more efficient to place servers having private networking in cabinet 350. Private networking, as would be understood by one of skill in the art, may be used to keep a particular server from communicating with other servers. Private networking is typically an upcharge from a Data Center. A potentially bigger problem, than problem 350, however, is that when the server has private networking (i.e., and the customer has therefore required private networking) but the inputted destination cabinet may not provide private networking functionality. This presents technical problems that the system must solve because migrating a server to a cabinet that did not meet a customer's requirements would be not be allowed. Thus, the system must solve the technical problems associated with guarantees of service as well as optimizing placement of migrated sever cabs to avoid inefficient placement of a server.

A second problem cabinet 352 shows that a server is already located in the desired cab unit of the destination cabinet. Thus, the system must also account for cabinet units that are already occupied by a server. A third problem cabinet 354 shows essentially the same problem as the first problem cabinet 350.

Referring again to the second problem associated with cabinet 352, the system of present disclosure provides technical benefits that allow the system itself to identify a proper and available cab without requiring a worker to physically check each cab and then each cab unit in the new data center to see if there is already a server in the desired location and to do so for every server to be migrated. Thus, the present migration tool provides a technical solution to a task that was not previously achievable by allowing a system itself to execute a server migration start to finish in accordance with the methods and processes described herein.

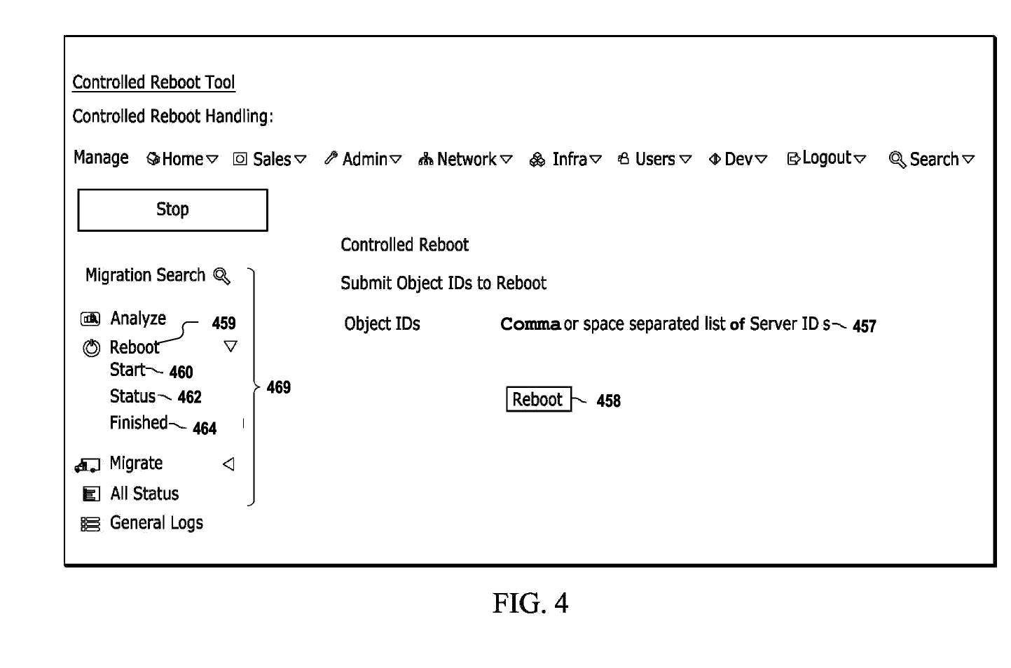

Referring to FIG. 4, an exemplary interface for conducting a controlled reboot function that may be displayed in response to the selection of “reboot” interface element 459 is illustrated according to some embodiments. In operation, a user inputs the particular server IDs into a text box entry form for object IDs field 457, and the migration tool will automatically reboot the inputted servers upon the user selecting the reboot button 458. The controlled reboot function has the advantage that a user does not need to physically enter the Data Center and manually perform a reboot on the particular server. Thus, a server that is malfunctioning or in otherwise need of a reboot may be rebooted remotely by the system user one or more software sequences. Of course, the system may require that the customer has provided the password for the particular server (or requires that the Data Center have administrative access to the assets) in order to utilize this controlled reboot function. Another advantage of the controlled reboot action is to avoid a time consuming boot scan during the manual migration and server setup by performing the action prior to migration. Referring to the illustrated left side buttons 469, the reboot action has a start menu 460, a status menu 462, and a finished menu 464. Selecting the start menu will display the controlled reboot form. Selecting the status menu 462, will display the status of the particular servers inputted into the ID field 457, such as the elapsed time of the reboot for the particular servers. Selecting the finished menu 464 displays the particular servers that have finished the controlled reboots.

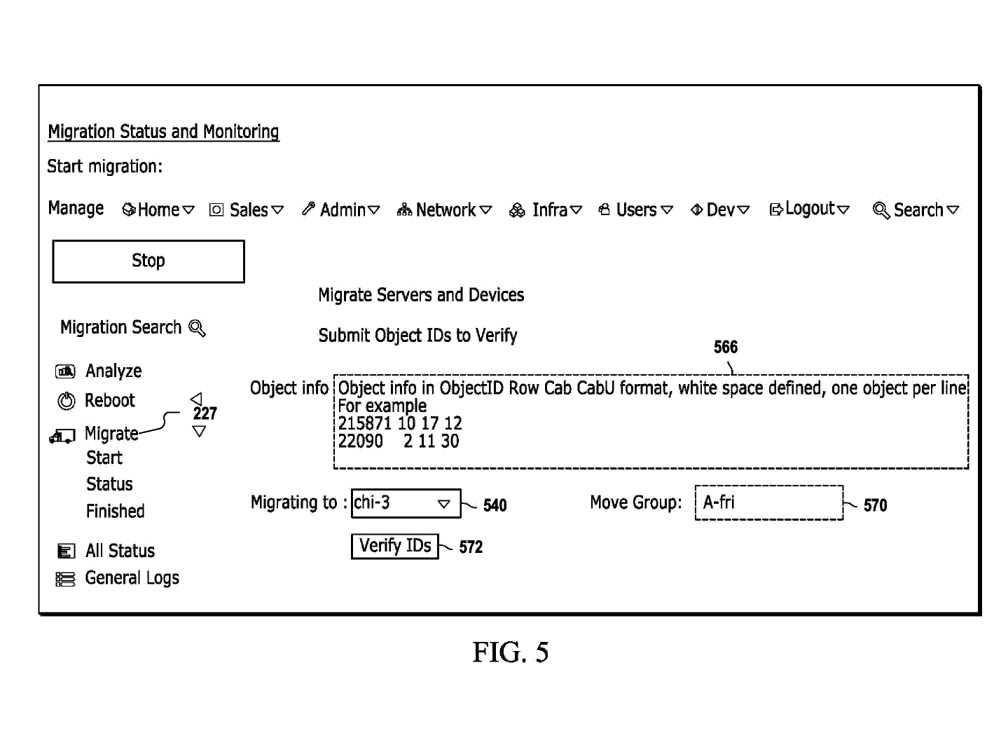

Referring now to FIG. 5, a screen shot of an exemplary interface for a migrate servers action according to certain embodiments is depicted. In these embodiments, the worker may have selected the migrate action 227 button. The worker starts the migration process by entering, such as by copying and pasting, all the corrected server information into object info field 566 and selecting the desired Data Center destination 14 in the destination field 540. A worker may also assign a move group label 570, which allows a worker to divide different groups of servers into different move groups. Establishing move groups can be helpful if the Data Center owner wishes to break up the move into separate steps or shifts to create logical groups and for example allocate a particular number of employees to handle each move group. Breaking a large migration of, for example, 1600 servers up into 400 server groups provides less downtime than trying to handle them all at once.

The tool can send a communication to customers, informing each customer that the movement of the server from the source Data Center 10 to the Destination Data Center 14 is being initiated.

The verify IDs button 572 verifies that the servers being migrated are still in use by customers as some of them may have been cancelled in between the time the data was last entered into the Analyze Tool.

The tool stores the current network configuration for each server. For example, it will determine the IP address of each server and whether it has private networking. Then, it shuts down the servers, if possible. For those servers for which there is no password, workers will need to manually shut down via console by plugging a keyboard into the server and selecting control-alt-delete, as known in the art, to manually shut down the server. Once these steps have occurred, then the servers are physically moved to a truck or other vehicle (after all servers are shut down, either remotely or manually). At this time, the migration tool will update the status of the servers as “In Transit.” It should be noted that a server has the capability of being associated with any IP address, so the one benefit realized from this aspect of the migration tool is the storing of the IP address and other attributes for each server prior to transport. The migration tool therefore ensures that each server has the same configuration when installed at the new Data Center. This saves considerable time in terms of instantly applying the configuration at the new Data Center. This also potentially reduces the frequency of errors in comparison to a situation in which a worker references a spreadsheet for the saved configuration and manually applied the saved configuration to each server.

Upon arrival at the Destination Data Center 14, if a worker places a server in the wrong destination rack, the migration tool cannot connect the server to the network. A worker then needs to find the misplaced server and inform the migration tool of the current location of such server so that the migration tool can apply the stored configuration to the server. The migration tool is therefore flexible in terms of allowing workers to simply update the migration tool in the event of a misplaced server.

If a server is placed in the wrong destination rack, and the switch correctly sends a MAC Change Notification to the SNMP Trap Receiver, the Migration Logic 24 will automatically update the location of the server and continue normally. If no SNMP Trap is received, the server will remain in In Transit status. Once all servers for the move group are racked, a migration technician can go through the remaining In Transit status migrations and manually initiate discovery based on destination information submitted when the migration was started. Any servers that still don't reach Network Applied status automatically and are not in their intended destination need to be tracked down manually in the Destination Data Center 14 by a Data Center Technician. When found, the destination cab and cab unit can be changed on the Migration Status Page and discovery can be forced again.

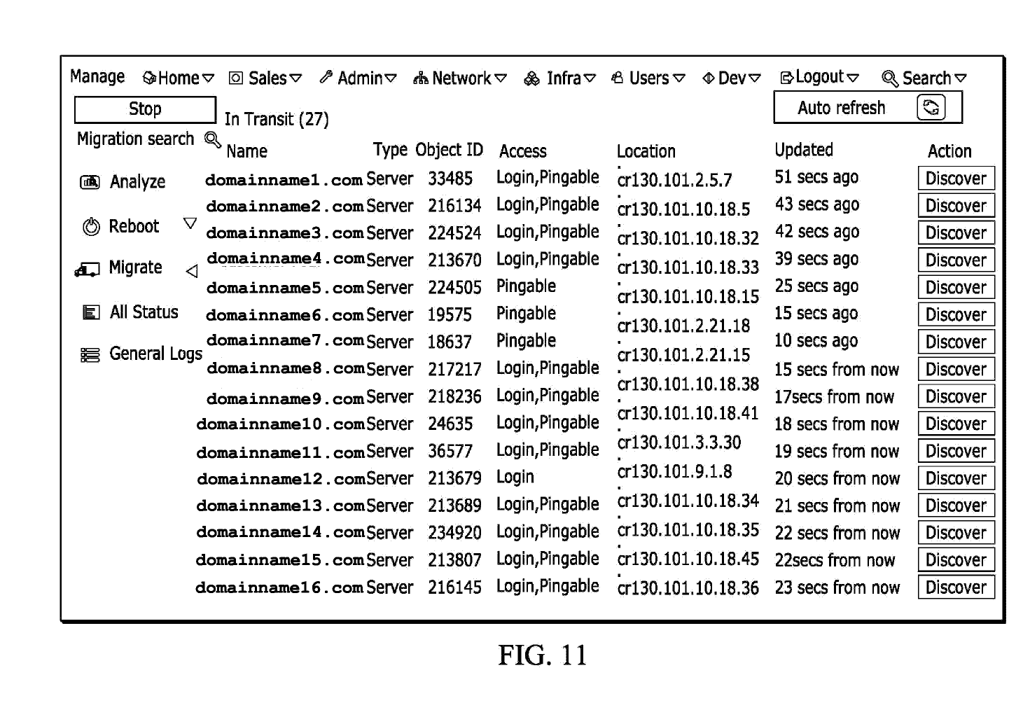

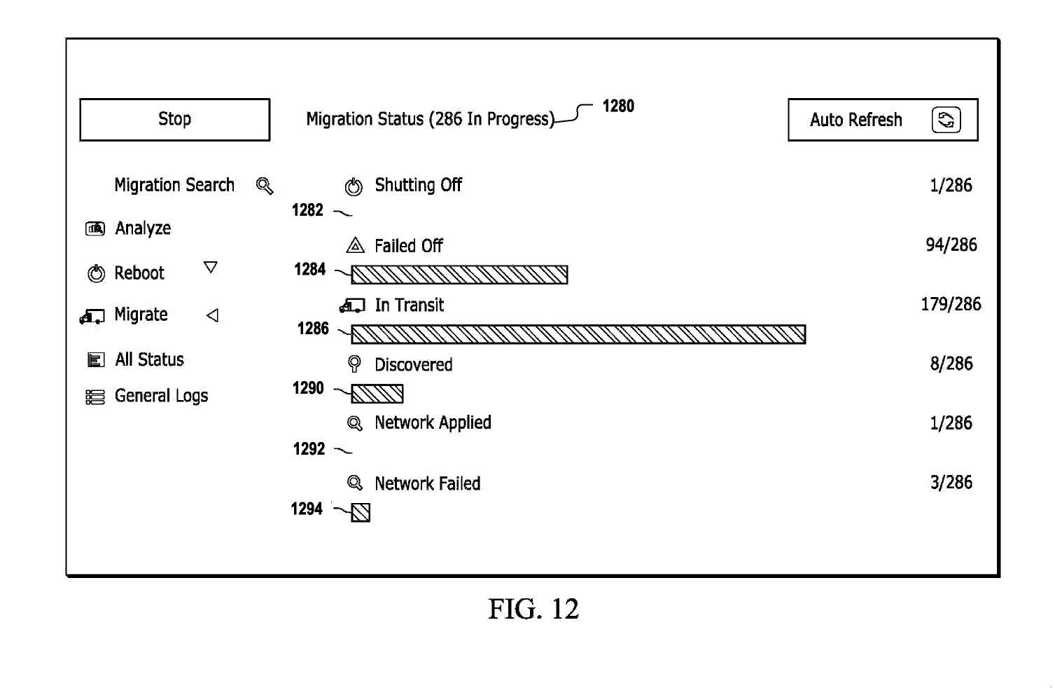

A misplaced server remains displayed in the in transit meter 1286 described in connection with FIG. 12, rather than appearing in “discovered,” “network applied,” or “network failed” meters 1290, 1292, 1294, respectively. Typically, toward the end of the process of migrating a group of servers, there are a few servers that remain displayed in the in transit meter 1286. Selecting the in transit meter 1286 allows a worker to see the remaining in transit servers (as shown by FIG. 11). The worker may utilize this information to physically locate those servers in the new Data Center and enter updated location information in the migration tool so that the migration tool can apply the stored configuration to the servers.

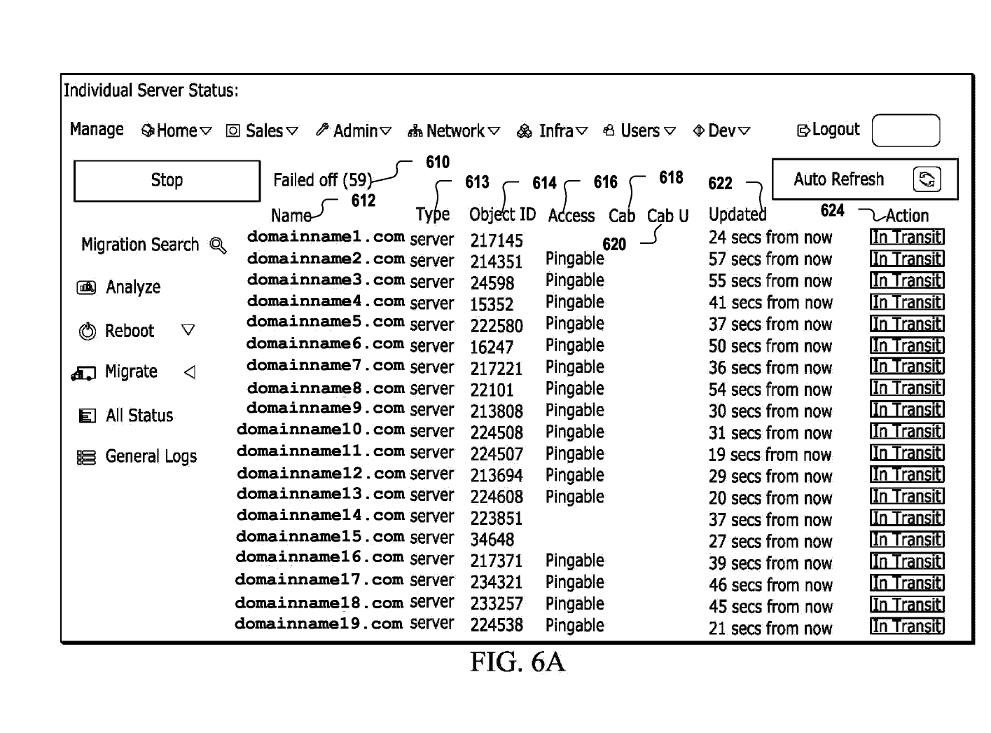

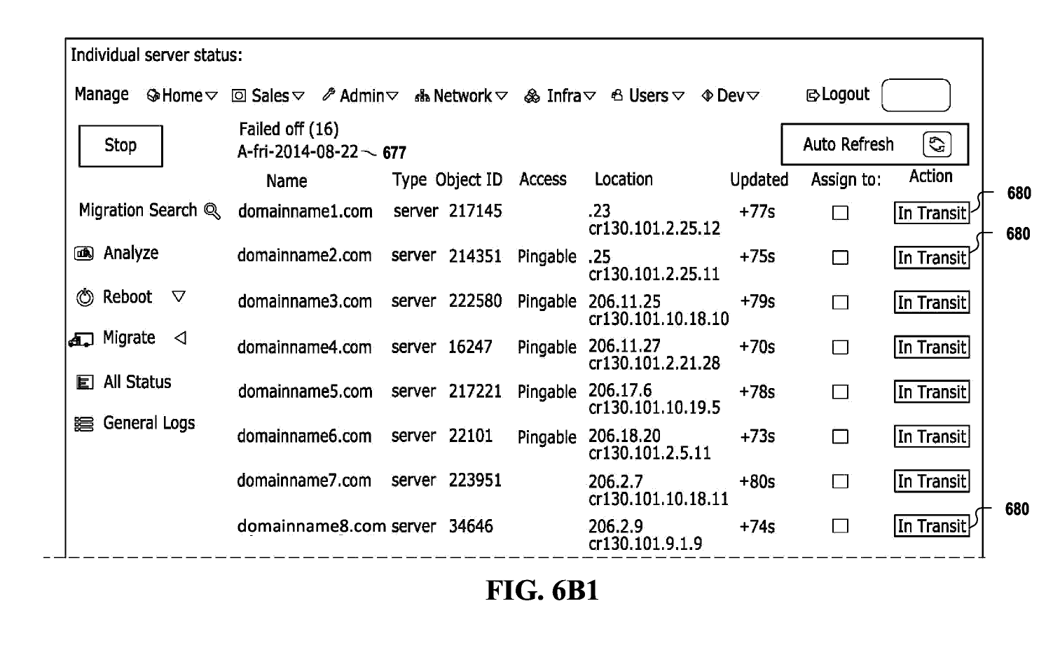

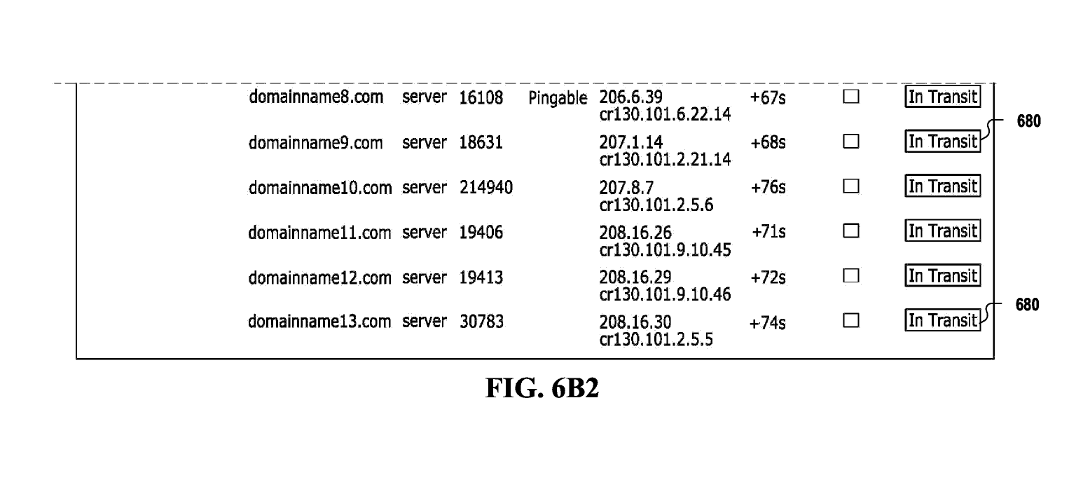

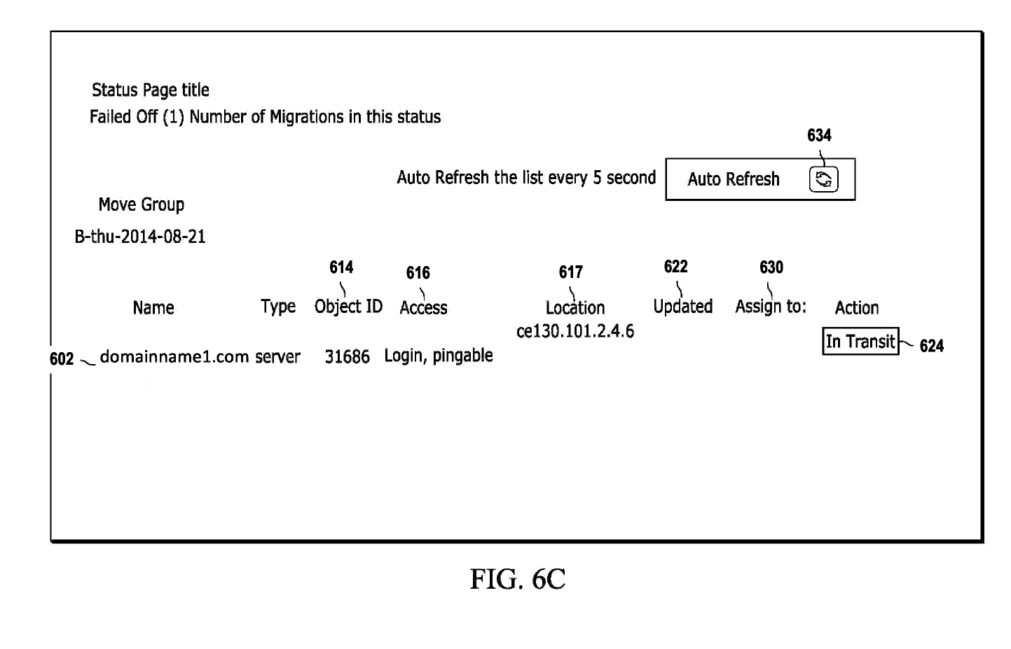

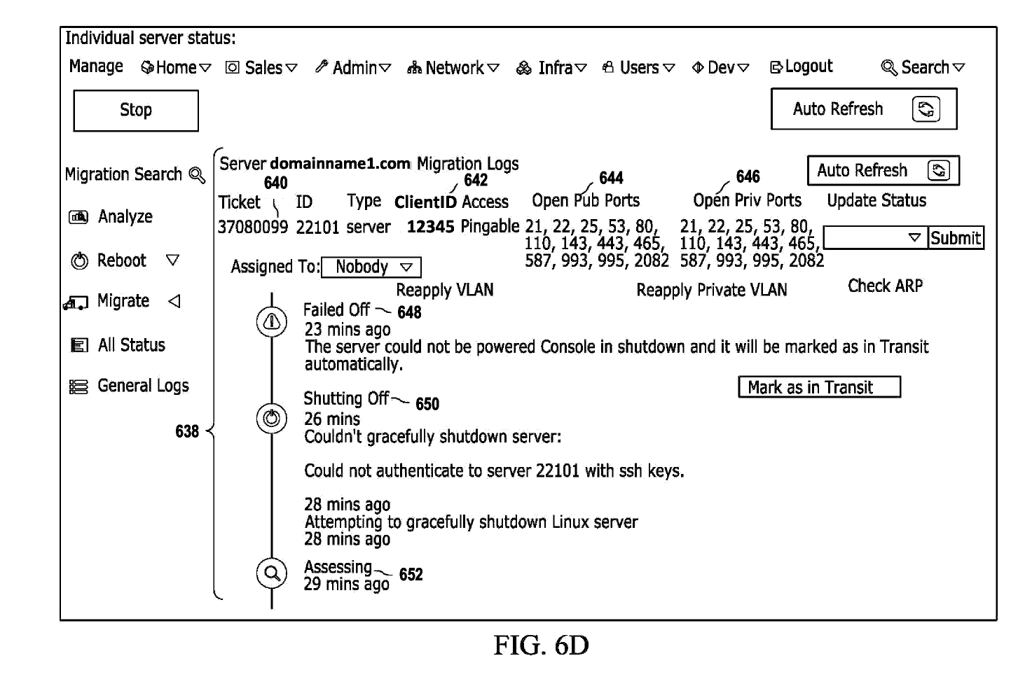

Referring now to FIG. 6A, shows a screen shot depicting an exemplary interface displaying server information for servers that have failed to shut off according to certain embodiments. In particular, information is displayed for a particular server which did not shut off after an attempted remote shut off, so these servers will require manual shut off. The total number of servers that have not shut off, i.e., “failed off”, is displayed in element 610. Column 612 displays the name of the server, column 613 displays the object type, column, 614 displays the object ID for the server, column 616 displays an indication of whether the server is pingable, columns 618 and 620 display the Cab and Cab unit information for the server, if any, column 622 displays information identifying when the information for that server was last updated, and column 624 displays an In Transit action that can be selected by a migration tool operator to mark move the server to In Transit status after shutting it off manually. Manual shut off may be accomplished by attaching a console followed by a ctrl-alt-delete or less desirably by a hard shut down where the worker simply unplugs the server. This could be detrimental to the end user services running on the server, and therefore automated shut down within the tool may be advantageous. In addition, the server's networking could be setup such that it is not accessible at all to our Migration Logic 24 and authentication may be prevented, such as due to a firewall that prevents attempts to ping the server.

FIGS. 6B1 and 6B2 show screen shots depicting an exemplary interface displaying server information for a particular move group according to certain embodiments. FIG. 6B1 shows an optional move group 677 designation should a Data Center owner that wishes to subdivide a Data Center move into separate groups and associated shifts of workers.

Another possibility is updating the particular server, with the in transit buttons 680. A worker may select the in transit button 680 to inform the migration tool that the server has been removed and is on its way to the destination. A server is considered to be “In Transit” when it is no longer pinging on its public and/or private IP address. In some cases, a server may not ping at all because it is firewalled or the Migration Logic 24 is otherwise locked out. Since it can't be determined when these servers have been shut down manually, they need to be updated by a Migration Tool technician to In Transit status.

Referring now to FIG. 6C, an enlarged screen shot is shown depicting an exemplary interface for displaying the types of fields illustrated in FIGS. 6A and 6B for a particular server according to certain embodiments. The first field is in the customer name column 612. Each customer name 602 in this column is a name field that identifies the customer/host name and links to the object's status page. Clicking on the customer name provides the specific server status shown in FIG. 6D. FIG. 6C also shows the server ID 614 column and an access field 616 column. In the embodiment depicted in FIG. 6C, object ID shown in column 614 links to a mange servers view. The access field column 616 shows “login,” which means that the Data Center has logged in to the server using either a password or other management access key. The access field 616 also shows “pingable” in the access status, “pingable” indicating that the server was pinging on its public IP the last time “pingable” was assessed. It should be noted that these screens could be modified to include both “Public Ping” and “Private Ping” to indicate the pingability of both interfaces, if applicable.

A location field 617 shows the location of the server, and it may show two locations before the server has been discovered in the Destination Data Center 14. For that time it will show the server location in the Origin Data Center 10 as recorded in the Server and Device DB as well as the intended Destination Data Center 14 location submitted when the migration was started. After discovery in the Destination Data Center 14, location field 617 will show its discovered location only. An updated field 622 shows the elapsed time since the server's status was updated. In this instance, the last time the displayed server was updated was 15 seconds ago.

An assign to box 630 is also illustrated and allows the user to assign the server to a particular worker. A down field (not shown) may also be provided to indicate how long the server has been down. Selecting an in transit button 624 clears any error and informs the migration tool that the particular server has been shut down and is ready for transport. The migration tool may also include an auto refresh button 634 should a worker wish to immediately refresh the tool rather than waiting for the tool to refresh on its own according to its preprogrammed refresh interval. In this regard, the tool could be designed with any desired preprogrammed refresh interval (e.g., every 15 seconds, 30 seconds, etc.).

With regard to FIG. 6C, based on the current migration status of the server a instead of always displaying “in transit” button 624, the system may display contextual action button. The contextual action button may take on a variety of forms, but generally shows show the most recent status log. For example,
If the status is Failed Off, a Mark In Transit button is shown.
If the status is In Transit, a Force Discovery button is shown with a rack select box and rack unit number box.
If in Network Applied status, a Mark Network Failed button is shown, allowing a migration tool tech to override the Migration Logic 24 or correct a manual mistake of marking the migration as Network Applied.
If in Network Failed status, a Mark Network Applied button is shown, allowing a migration tool tech to override the Migration Logic 24 or correct a manual mistake of marking the migration as Network Failed.

FIG. 6D shows a screen shot depicting an exemplary interface for displaying a migration log for a particular server according to certain embodiments. This embodiment shows a migration log 638 of a particular server that currently has a failed off status, which may be displayed after clicking customer name 602 described in connection with FIG. 6C. Every server may have a ticket number 640 associated with it, and the ticket number 640 may link out to the ticket in an external support system. The ticket is generated by the migration tool and is used as a reference in sending communications to a customer. A client ID 642 may also be provided, which indicates a particular customer identifier. The client ID 642 may link out to an external customer account management system.

The migration log 638 may also display any open public ports 644 and open private ports 646 that are available in the particular server. As will be apparent to one of ordinary skill in the art, “public” ports relate to shared information while “private” ports are more secure in terms of communication between the server and the network. The migration log 138 provides the status history of the server, such as a most recent event 648, in this case a failed off condition where the server could not be powered off. In this embodiment, the recent event 648 shows that a worker consoled in order to shut down the server. In other scenarios, other textual messages will be displayed next to recent event 648 in accordance with the present description. The log also shows a listing of prior events 650 and 652, which may be displayed chronologically. The event 650 shows attempts to shut off the server and because those attempts were unsuccessful. Thus, the log 638 shows the most recent failed off 648 condition. The log 638 also shows an earlier even 652 where the server indicated that it is assessing migration status. For each event, the log 638 displays information describing the nature of the event and displaying the time that the event took place.

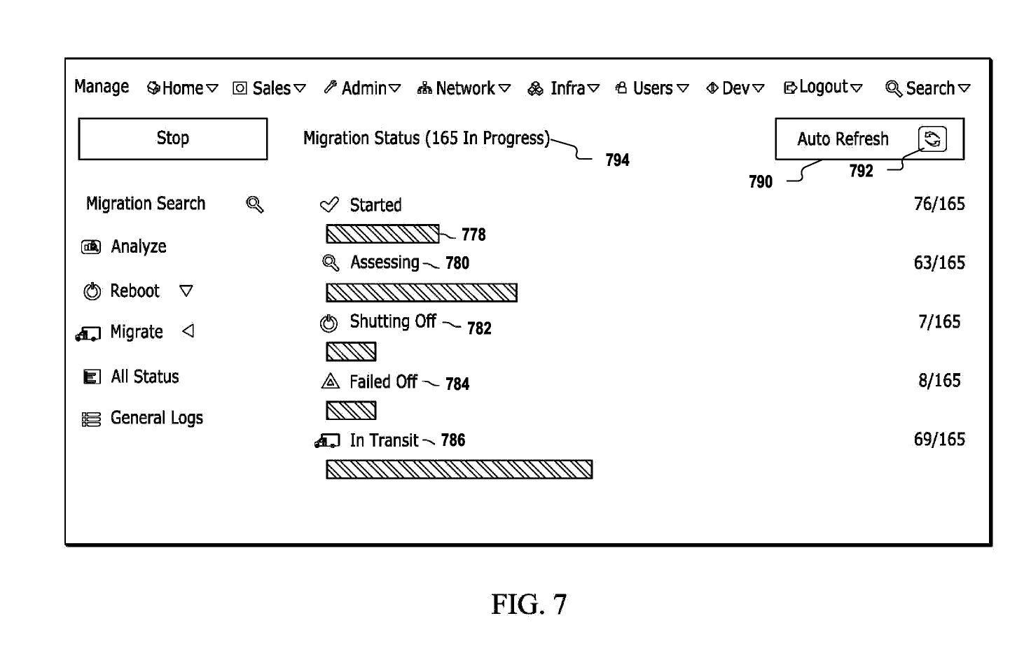

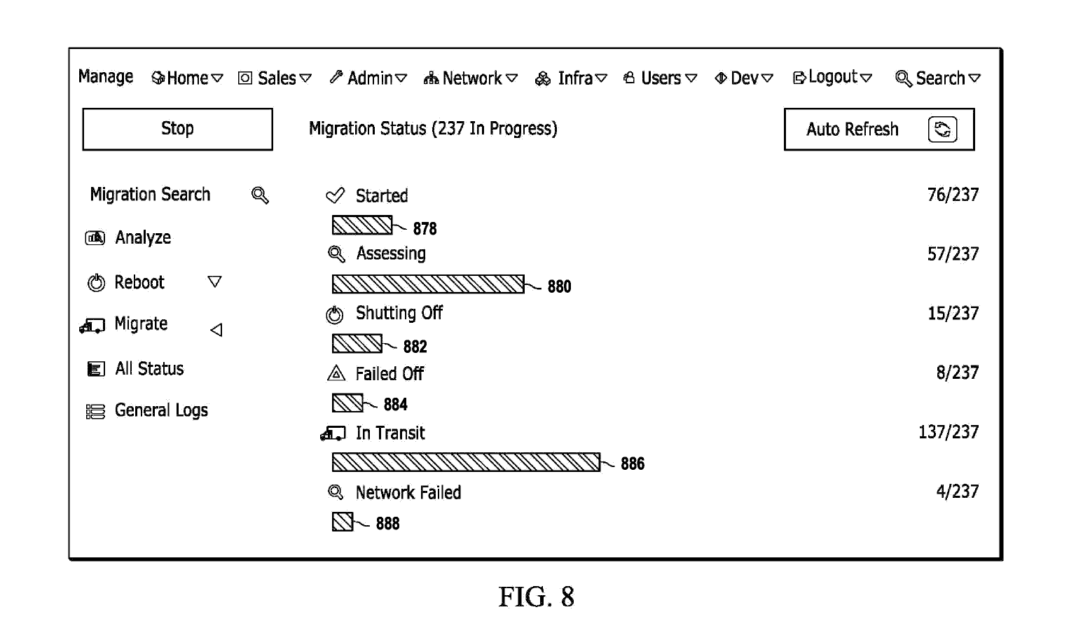

FIGS. 7 and 8 illustrate the migration status viewer. FIG. 7 depicts a screen shot of an exemplary interface for displaying migration status meters for a particular point in time during a migration according to certain embodiments. FIG. 8 depicts a similar screen shot of an exemplary interface but also depicting an additional network failed meter that may appear at a point during migration process in which one or more servers have failed to connect according to certain embodiments. Each of the illustrated fields is dynamic, continually updating.

Referring to FIG. 7, a started meter 778 shows the quantity of servers that have been entered into the tool. Each page of the Migration Tool that shows migration statuses (which does not include the Analyze Tool, Start Migrations form, Controlled Reboot Start form, etc) can be set to automatically refresh periodically in order to show up to date information. This feature can be toggled on and off by clicking the Auto Refresh button 790 on the top right of the page. A refresh can be requested on demand by clicking the Refresh button 792 next to the Auto Refresh button 790 indicated by an icon of two arrows in a circle within the Refresh button 792. In one embodiment, the Refresh button 792 indicates that a refresh is in progress by rotating the icon of two arrows.

In one embodiment, the interface displayed in FIG. 7 may be shown on a separate display screen as a worker inputs information into the interface described in connection with FIG. 5. The assessing meter 780 indicates that the tool is reviewing the configuration such as the aforementioned IP address, private networking capability, and other attributes. A shutting off meter 782 displays the quantity of servers that the Migration Logic 24 is currently attempting to shut off. A “failed off” meter 784 indicates the quantity of servers that have failed to shut off. An “in transit” meter 786 indicates the quantity of servers that have successfully been shut down and are thus in transit to the new Data Center. It should be noted that the meters 780, 782, 784, 786 are dynamic, continually tracking the progress of each server and thus the overall progress of the migration. For example, in FIG. 7, 165 servers are being tracked as indicated by status field 794. The assessing meter 780 shows 53 servers being assessed, and the shutting off meter 782 shows 7 servers shutting off. Although depicted as bar graphs on the left side of the interface and totals on the right hand side of the interface, in other embodiments the total number represented by each meter may be displayed alongside or within the respective bar graphs. At a later point in time, the meter 780 might shows 52 servers being assessed and the meter 782 might show 8 servers shutting off (i.e., one server changing from an assessing status to a shutting off status).

In one embodiment, clicking the assessing meter 780 displays all servers being assessed at that time. Likewise, clicking the started meter 778 displays all servers that have been entered into the migration tool 230. Likewise, selecting the shutting off meter 782, failed off meter 784, or in transit meter 786, displays all servers currently shutting off, failed off, or in transit, respectively.

Referring now to FIG. 8, a screen shot depicting an exemplary interface for displaying migration status meters and also depicting an additional network failed meter that may appear at a point during migration is shown. This embodiment shows an additional “network failed” meter 888 that may appear when one or more servers have failed to connect at the new Data Center. The network failed meter 888 may be designed so that it only appears on the screen once at least one server has been identified as failing to connect. If no servers have failed to connect, then the system may only display started meter 878, assessing meter 880, shutting off meter 882, failed off meter, 884, and in transit meter 886.

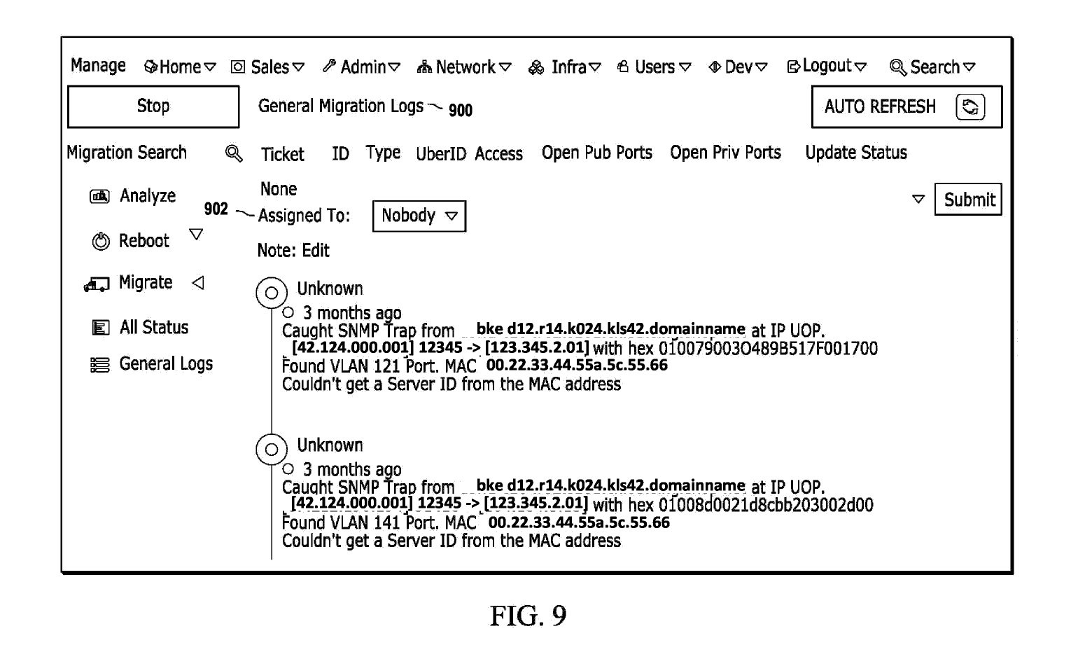

FIG. 9 is a screen shot depicting an exemplary interface for displaying a general migration log according to certain embodiments. As shown in FIG. 9, General Migration Logs 900 contains logging information describing errors that cannot be related to any known migration, such as MAC Change Notification traps that do not match with any currently migrating servers or general debugging messages about the Job Scheduler, Migration Logic 24, or Network Automation. A beneficial use of the General Migration Logs 900 tool is for discovering and/or debugging issues with the Migration Tool. In this way, the system generates a report of general errors, as well as errors not associated with any current migration, and displays them to the user in an easy to digest manner. An assign to box 902 is also illustrated and allows the user to assign the server to a particular worker.

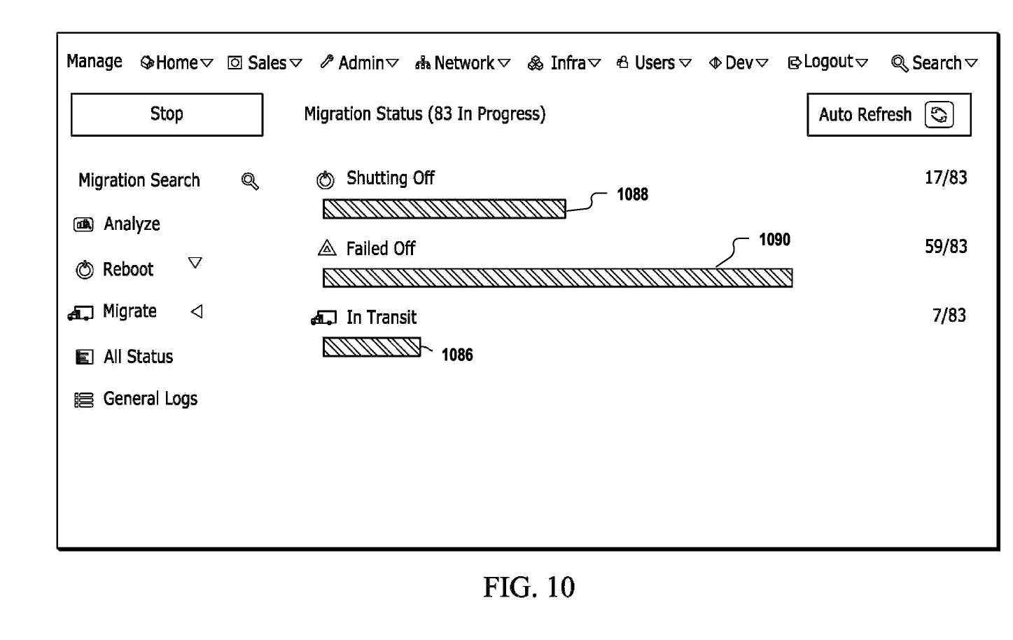

Referring now to FIG. 10, FIG. 10 is a screen shot depicting an exemplary interface for displaying migration status according to certain embodiments As described in connection with prior figures, each of the elements of the meters 1086, 1088, and 1090 may be selected by a user to display further information. For example, selecting shutting off meter 1088 will display information detailing each of the servers that is shutting off, and selecting failed off meter 1090 will display detailed information for each of the servers that have failed off status 1090. Referring to FIG. 11, if a worker were to click the in transit meter 1086 described in connection with FIG. 10, the FIG. 11 in transit screen would appear, displaying all servers currently having in transit status. is a screen shot depicting an exemplary interface for displaying a log of servers designated as in transit at a particular point in time during a Data Center migration according to certain embodiments. Similar to as described in connection with FIG. 6, the individual columns display the name of the customer, the server type, the object ID for the server, an indication of whether the server is pingable, the server location (such as the Cab and Cab unit information, if any), information identifying when the information for that server was last updated, and the latest action for the respective serve migration.

FIGS. 12-22 are a set of related screen shots depicting exemplary interfaces for displaying various aspects of the server migration process and taken during a particular points in time throughout the process according to certain embodiments and which illustrate various status meters and corresponding migration log pages reachable by clicking the various status meters described in connection with the various figures herein.

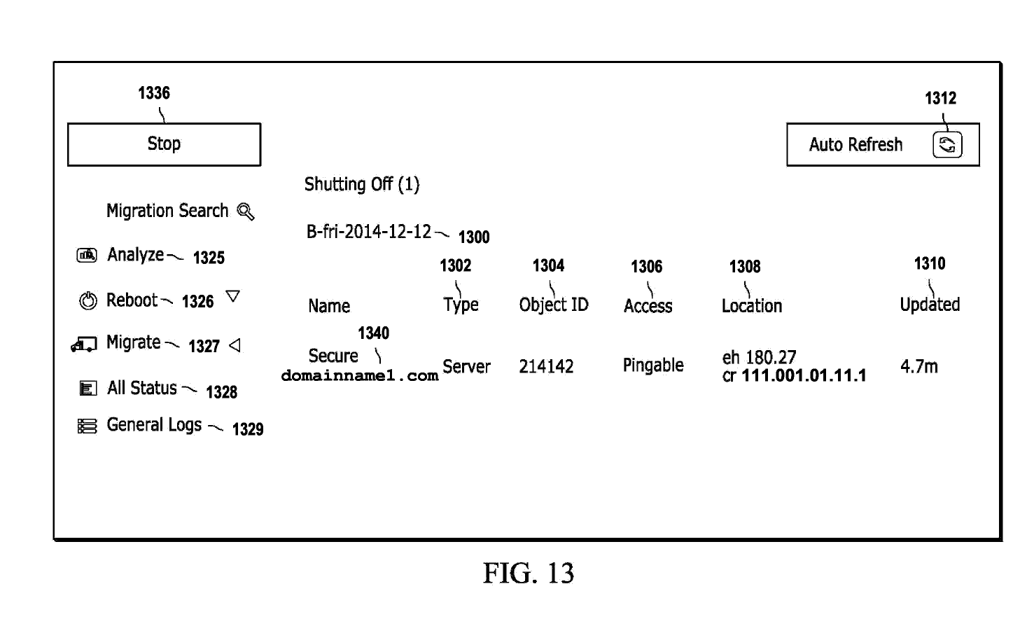

FIG. 12 shows a migration status with 286 servers in progress by interface element 1280. Of the 286 servers, the shutting off meter 1282 shows 1 server shutting off, the failed off meter 1284 shows 94 servers in failed off state, the in transit meter 1286 shows 179 servers in transit, the discovered meter 1290 shows 6 servers discovered, the Network Applied meter 1292 shows 1 server having networked applied status, and the network failed meter 1294 shows 3 servers having network failed status. Clicking the shutting off meter 1282 of FIG. 12 opens the FIG. 13 display to show the details of the 1 server having shutting off status.

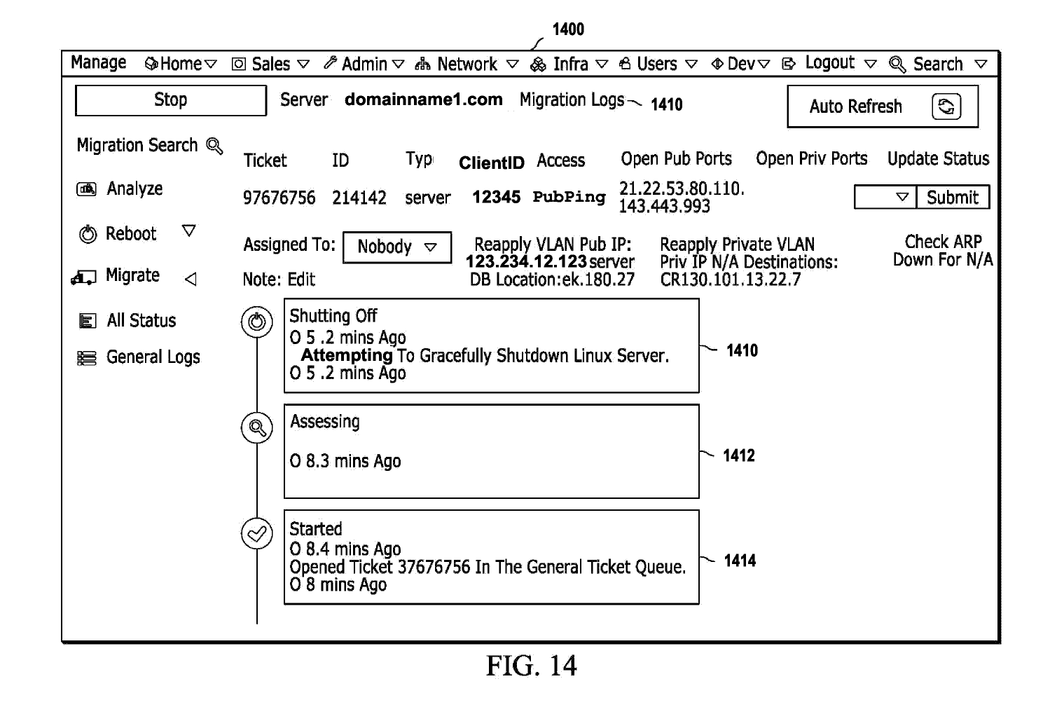

Referring now to FIG. 13, the server status information includes a move group 1300 as well as an object type 1302. As described above in reference to element FIG. 6C, other information includes the object/server ID 1304, the access condition 1306, the server location 1308, and the update status 1310. The display embodiment depicted in FIG. 13 also includes the auto refresh button 1312. Clicking the customer name 1340 of FIG. 13 opens the interface depicted in FIG. 14, illustrating the migration log 1410 of that particular customer server in window 1400 according to some embodiments.

Referring now to FIG. 14, the window 1400 displayed in response to clicking customer name 1350 described in connection with FIG. 13 shows three events 1410, 1412, 1414 for that customer, which are shutting off, assessing, and started conditions, respectively. Each event contains information describing the vent, as well as any identifying information for the event, such as the time the event took place. The events may displayed in chronological order and in some embodiments each event may collapsed by clicking the corresponding icon.

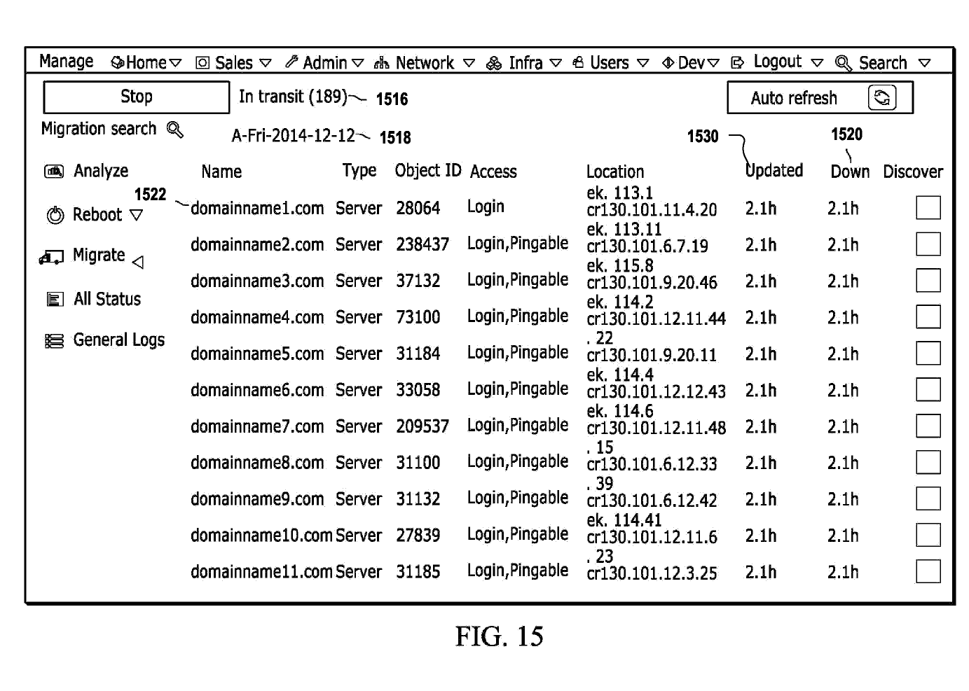

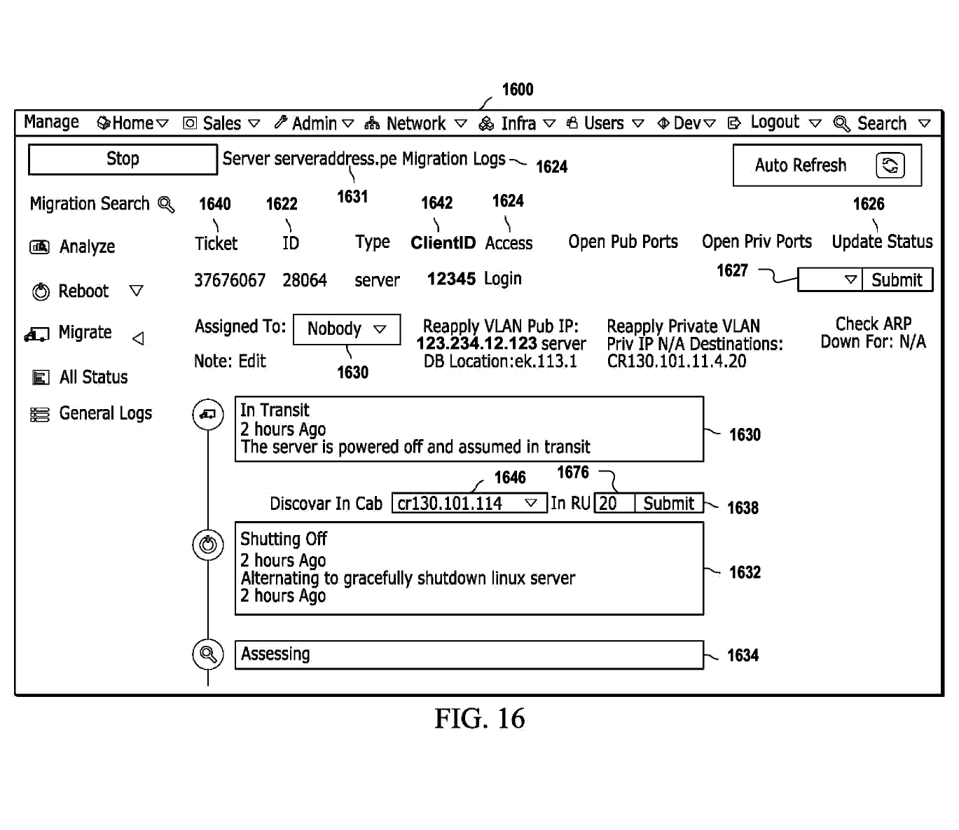

Referring again now to FIG. 12, clicking the in transit meter 1286 of FIG. 12 opens interface depicted in FIG. 15, illustrating the in transit status display 1516 of all in transit servers. As shown in FIG. 15, the in transit status page 1516 shows that 189 servers that the system is monitoring currently having in transit status. The total number of shown as in transit in FIG. 15 (i.e., 189 servers in transit) is different from the total number of serves shown as in transit in connection with the in transit meter 1286 of FIG. 12 (which showed 179 servers in transit) because the, in some embodiments, the number of serves is updated in real-time, each time the interface loads, or when the interface is refreshed. The number of servers in transit (as well as other meters) therefore varies between the depicted interfaces because the status of servers can change any minute as the migration continues and the various meters are dynamic to track the progress of each server at every stage of the Data Center migration. It is to be noted that FIG. 15 does not show all 189 servers, but instead shows the first page of these 189 servers, beginning with a group A migration group 1518. During actual display of the interface, a worker could scroll down using a scroll bar or click a next button (not shown) to see the additional in transit servers and, for example, to see other servers of the group A migration group as well as any other migration groups (e.g., group B, C, etc.). The interface shown in FIG. 15 in transit display 1516 also include a down time indicator 1520 for each server, which may or not be included in certain embodiments for any other the other various interfaces described herein. An updated indicator 1530 also shows the last time the status or information for the server referenced by server name 1522 was updated. Clicking on server name 1522 displays an interface for a migration log, such as the exemplary interface depicted in FIG. 16.

Referring now to FIG. 16, upon clicking on the one of the server names 1522 described in connection with FIG. 15, the system displays a window 1600 containing a migration log 1624 for that particular server and which displays a ticket field column 1640, ID info column 1622, access info column 1624, as well as additional columns of interest. The interface may also implement and provide an update status 1626 drop down box that may allow a worker to update the status of a particular server to a different status. Migration events 1630, 1632, and 1634 are also shown in this embodiment. The interface also provides a second drop down box 1646 that allows a worker to select from one or more available cabinets in the new Data Center and a third drop down box 1676 for entering the rack unit (RU) in the new Data Center. A submit button 1638 is also provided to submit the information entered in drop down box 1646. The submit button 1638 submits the Discover in Cab form which forces discovery of the server in the Destination Data Center 14 in the specified cabinet and at the specified rack unit listed in drop down menu 1646. The Cab and RU (rack unit) values default to those submitted when the migration was started.

The Update Status form 1626 allows a worker to override the server's current status and set it to either Started, Assessing, In Transit, Network Applied, Network Failed, or Cancelled using drop down menu 1627. Among other things, this allows a worker to override the status of a migrating server if the current status does not provide the appropriate contextual button in its status logs. If a server has already been discovered but needed to be moved or was discovered in the wrong location, a worker can also update the status to In Transit. If the status is In Transit, a Force Discovery button is shown (such as submit button 1638) with a rack select box and rack unit number box (such as drop down box 1646) and the worker can then use the force discovery button in the In Transit status log to update to the correct location. On the other hand, if a server was somehow left behind at the Origin Data Center 10 or wasn't supposed to be moved but was still entered into the migration tool, it can be marked as Cancelled. An assign to box 1630 is also illustrated and allows the user to assign the server 1631 to a particular worker.

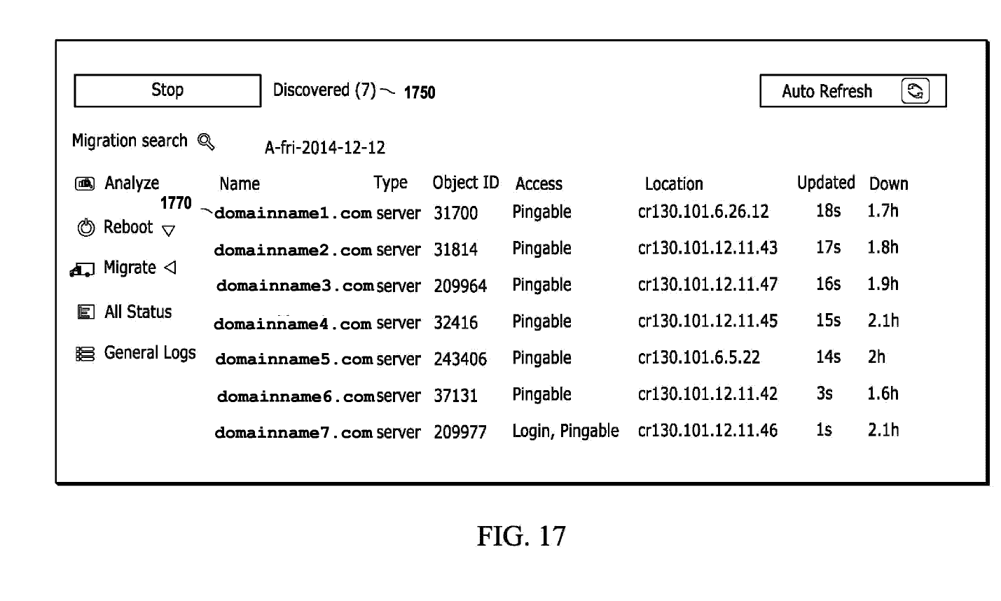

Referring back again to FIG. 12, the discovered meter 1290 shows 8 servers having discovered status. In one embodiment, clicking on the discovered meter 1290 of FIG. 12 causes the system to display the interface as shown in FIG. 17. FIG. 17 shows the discovered status interface 1750 for each of the discovered servers. The FIG. 17 status display 1750 reflects 7 servers having discovered status rather than the 8 identified in FIG. 12 as the interface is dynamically updated in real-time and some small amount of time has likely elapsed between the FIG. 12 view and the FIG. 17 view (e.g., perhaps a minute or two or some longer period of time). As shown in FIG. 17, the list of discovered servers is displayed along with their name 1770 and other status information, including server type, object ID, access, location, last updated, and down time.

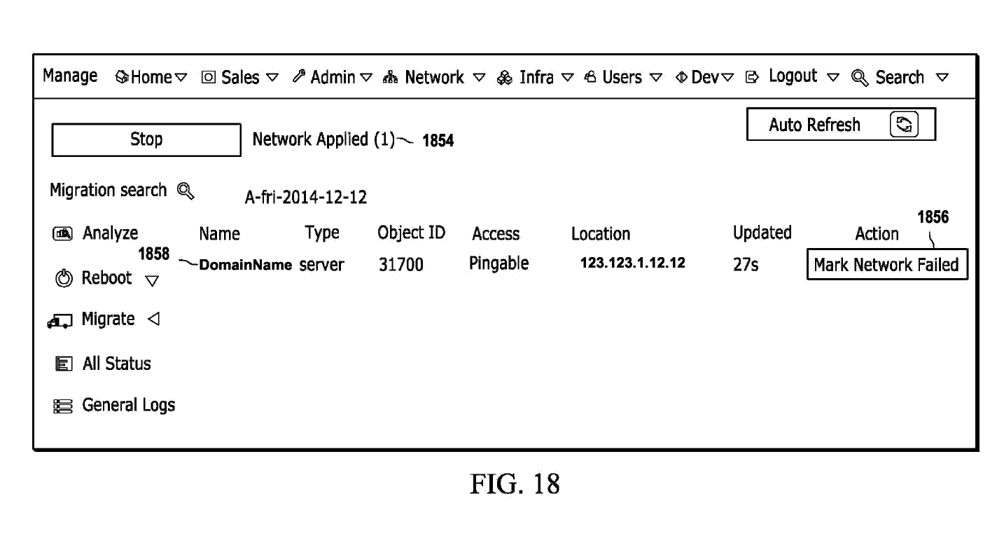

Referring back again to FIG. 12, in one embodiment, clicking the Network Applied meter 1292, which shows 1 server having Network Applied status, causes the system to display the interface as shown in FIG. 18. FIG. 18 depicts an exemplary Network Applied interface 1854 for displaying information related to servers having network applied status and showing the attributes for those servers. In this example, only one server had networked applied status and the interface shows the attributes of that one server, including server name, server type, object ID, access, location, and last updated. In contrast to the discovered status interface described in connection with FIG. 17, the network applied interface of FIG. 18 shows a mark network failed button 1856 that allows a worker or user to change the status of server 1857 to network failed.

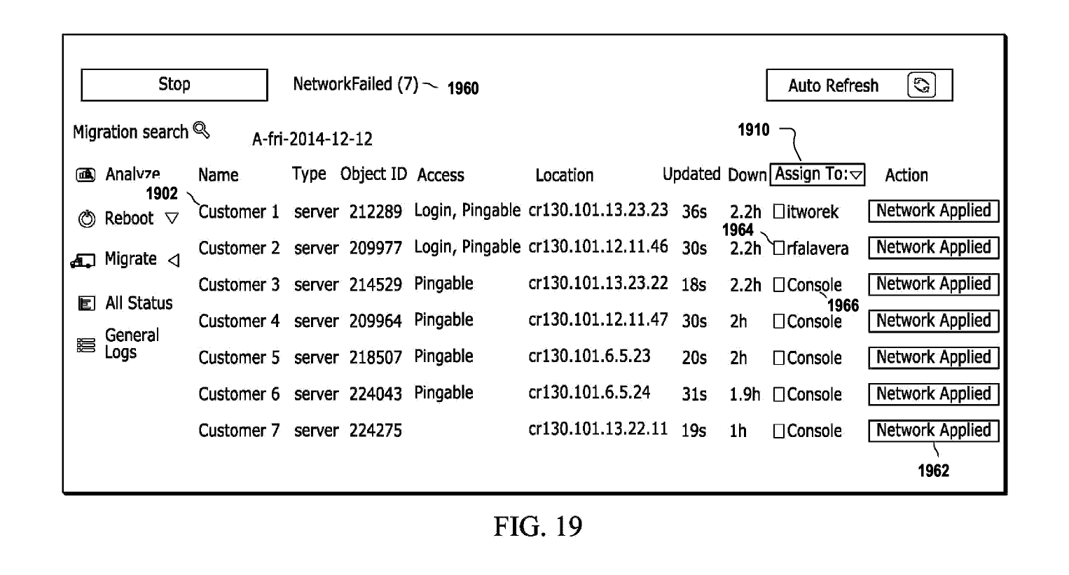

Referring again to FIG. 12, in one embodiment, clicking the network failed meter 1294 causes the system to display the interface as shown in FIG. 19. FIG. 19 depicts an exemplary Network Failed interface 1960 for displaying information related to servers having network applied status and showing the attributes for those servers. FIG. 19 shows that a Network Applied button 1962 and particular assign to fields 1964, 1966. Depending on the scenario, general assignments can be made, including, but not limited to: Console, Hardware Failure, Net Ops, Find Me. When a migrating server is in Network Failed status, these general assignments are useful to categorized the error associated with the failed migration and indicate which worker or group of workers should be looking into the problem. In addition to the general assignments, the system may provide user names for all the technical workers in the organization as well as the Myself alias for whoever is logged into the migration tool at any given moment. Thus, a DC (“Data Center”) Tech can open the Network Failed status page, scan for any servers assigned to Console, for example, assign a number of the servers to the “Myself” alias using the assign to 1910 drop down menu, then go into the Data Center, grab a console cart and start checking on those servers. Similarly, a Net Ops tech can take any Net Ops assignment or look through unassigned migrations and mark them with a general assignment using drop down menu 1910 since they can probably determine the general issue. In some embodiment, general statuses will be automatically set by the system in some situations based on the systems determination of a reason a migration is put into Network Failed status. For example, when a server is discovered and is not pinging after the specified timeout, the system can assign the server to “Console” so someone can check on its boot progress. If a server is manually discovered but there is already another server in the cabinet and rack unit it's supposed to be in, the system can automatically assign the migration to “Find Me” in order to indicate that the migrating server needs to be manually tracked down in the Destination Data Center 14.

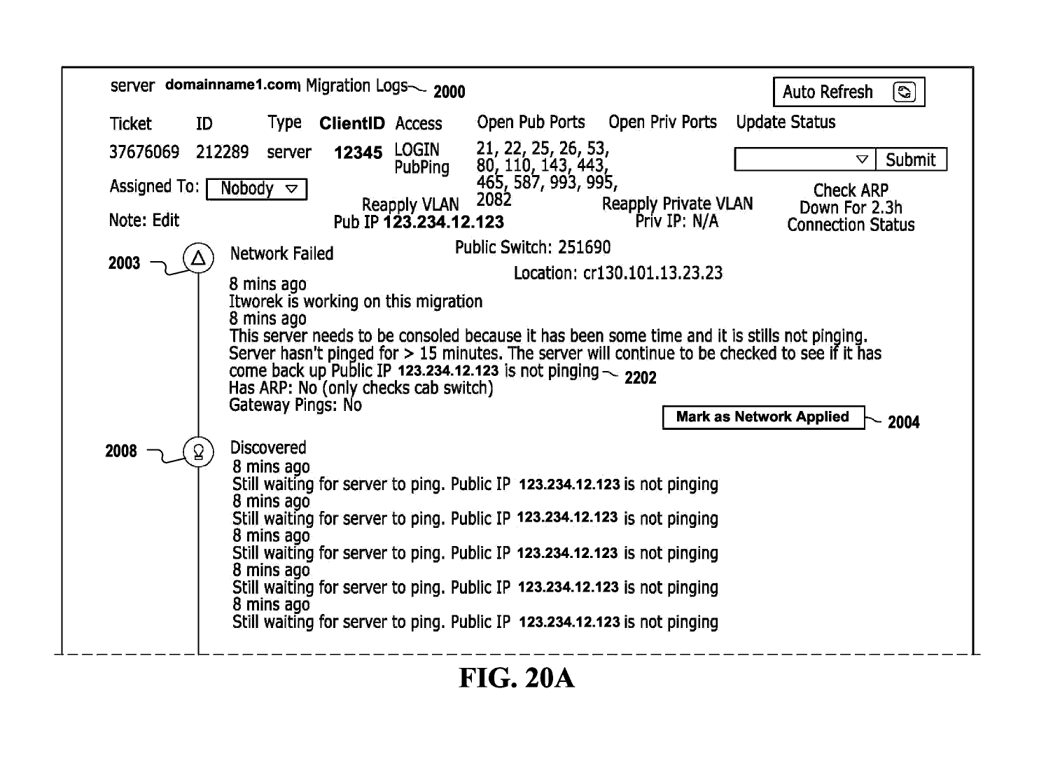

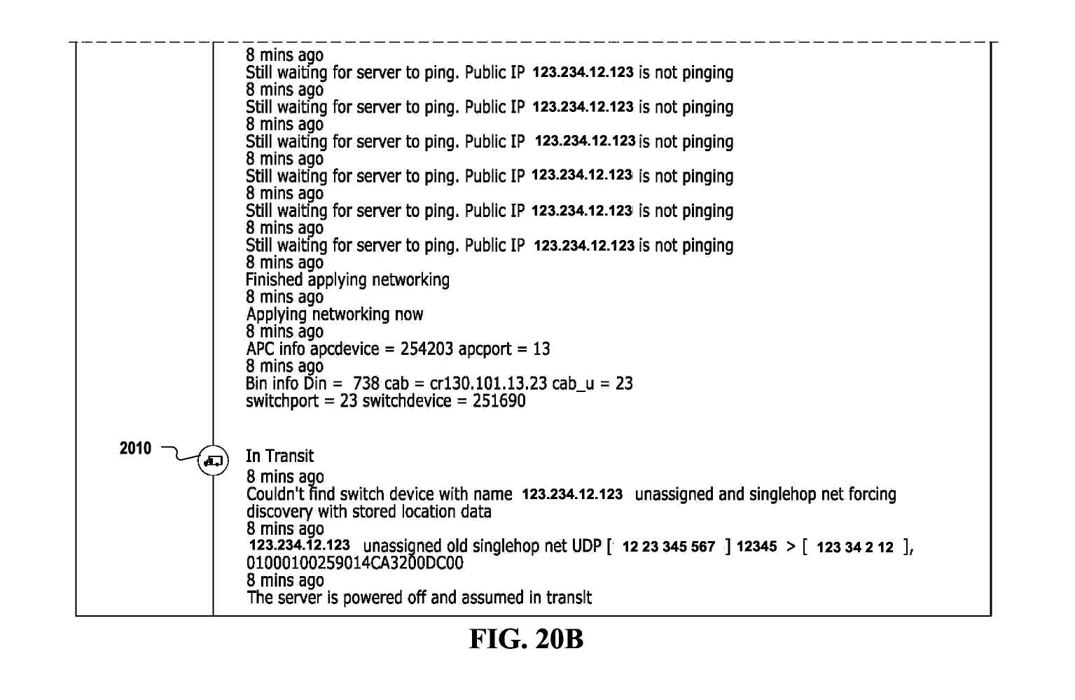

FIG. 19 also shows server 1902, which is one of seven servers having “network failed” status at that point in time. Clicking on the server name 1902 causes the system to display the interface as shown in FIGS. 20A-B, which are depicted on two separate sheets for clarity reasons. FIGS. 20A-B depicts an exemplary Migration Logs interface 2000 for displaying migration log for the server 1902 described in connection with FIG. 19. In this example, the migration contains a most recent event information 2002 for a Network Failed Event 2003 that indicates why server switched to network failed status and provides information that may be useful in debugging and analyzing the issue. In addition to the most recent event 2002 information, a chronological timeline of previous events is also displayed, including Discovered event 2008 and In Transit event 2010, as well as the information surrounding each event.

The interface depicted in FIGS. 20A-B also implements and provides a Mark as Network Applied button 2004. In some embodiments, a worker may use the Mark as Network Applied button 2004 to update the server to Network Applied status. For example, the networking issue could have been manually resolved but not detected by the migration logic. A migration worker or technician who verifies that the server is online can manually override the system and mark the server as network applied.

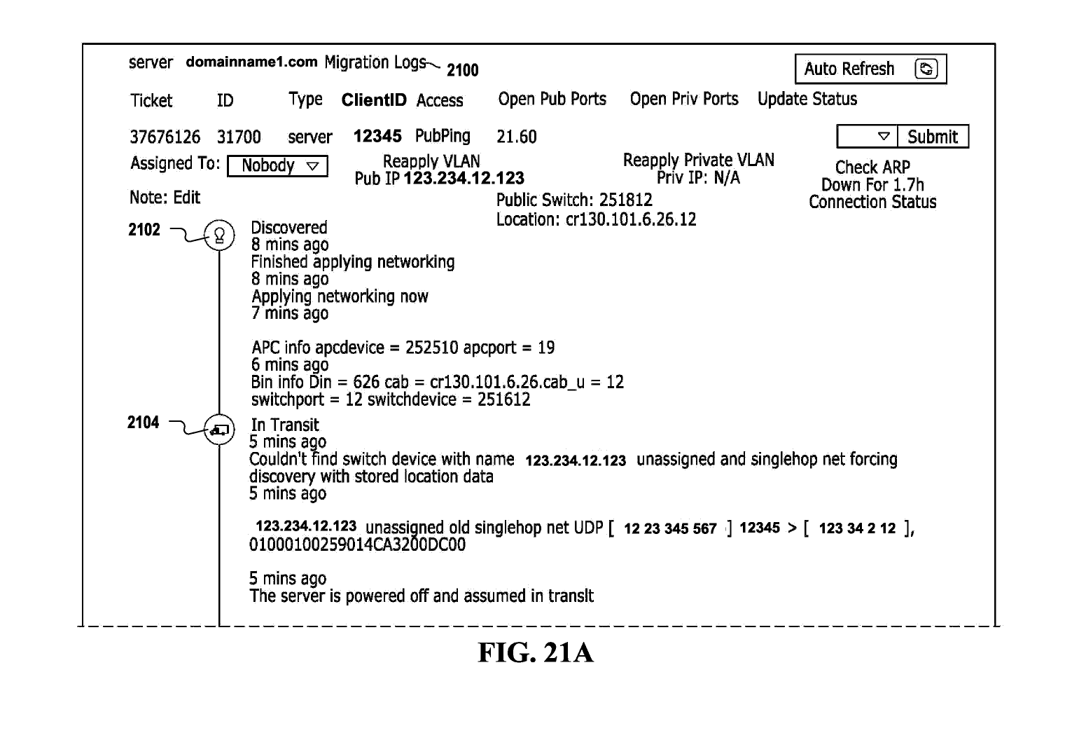

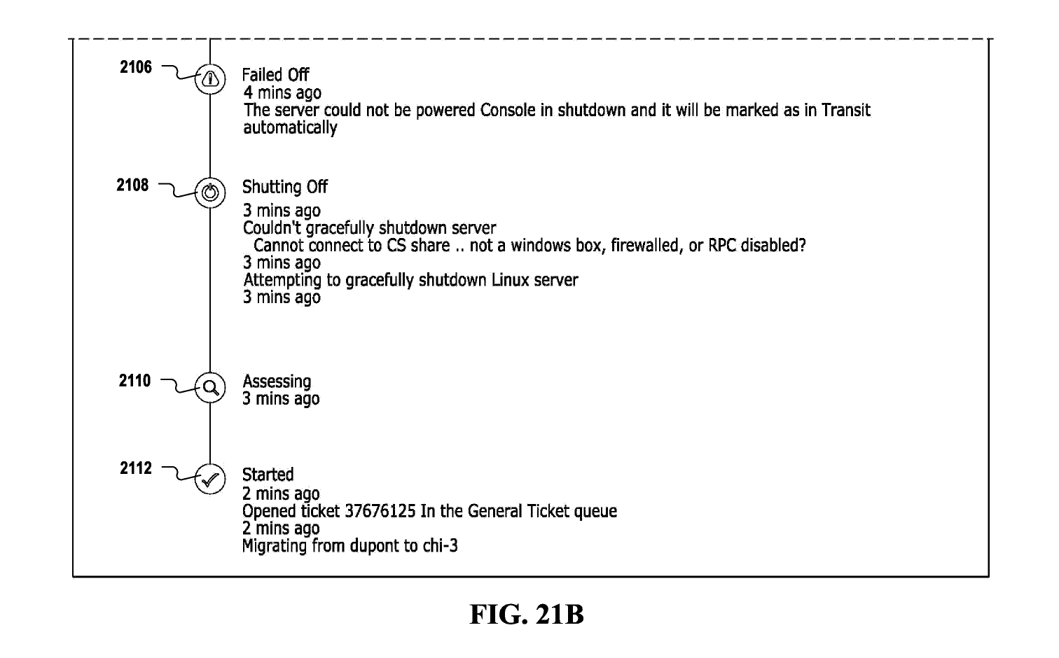

Referring now again to FIG. 17, recall that in some embodiments, the system displays the interface as shown in FIG. 17 in response to clicking on the Discovered meter 1290 described in connection with FIG. 12. Thus, FIG. 17 shows the Discovered status interface 1750 for each of the servers having Discovered status. Once the system has displayed the interface depicted in FIG. 17, in some embodiments, clicking on the name of a server 1770 may also cause the system displays the interface shown in FIGS. 21A-B, which are depicted on two separate sheets for clarity reasons.

FIGS. 21A-B depict an exemplary interface for displaying a migration log 2100 for the server 1770 described in connection with FIG. 17. Similar to the interface display described in connection with FIGS. 20A-B, the interface display for the Discovered server includes a log of most recent events, including a Discovered event 2102, In Transit event 2104, Failed Off event 2106, Shutting Off event 2108, Assessing event 2110, and Started event 2112. Alongside each event, the server displays the information describing the events surrounding the event as well as what time the events took place.

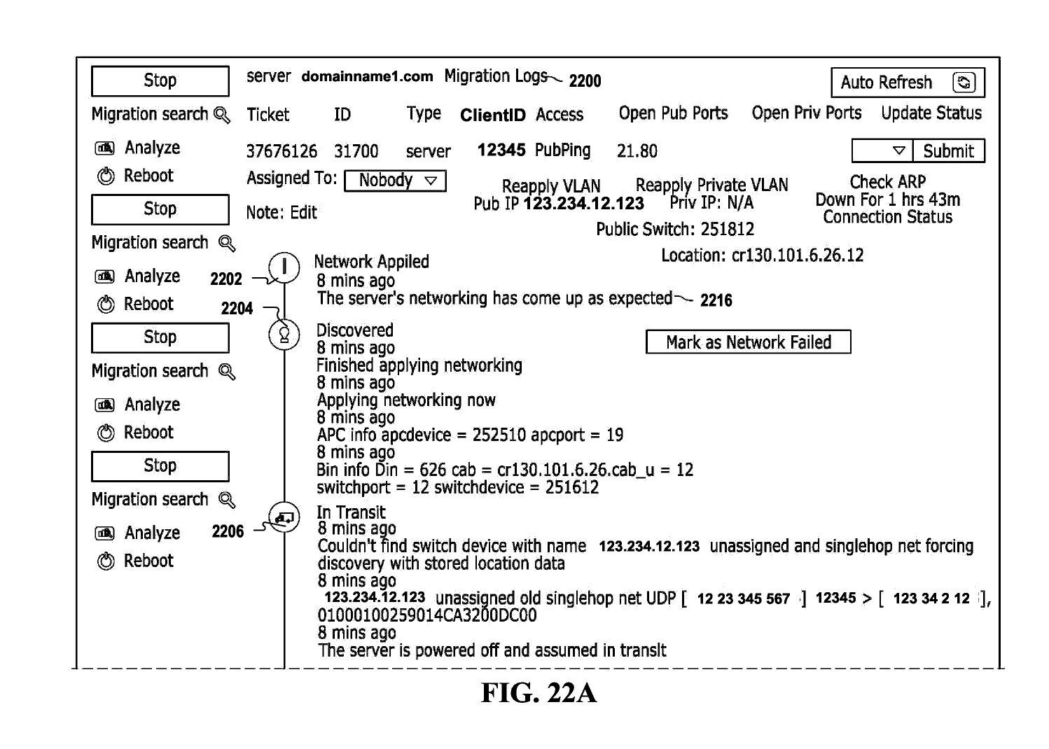

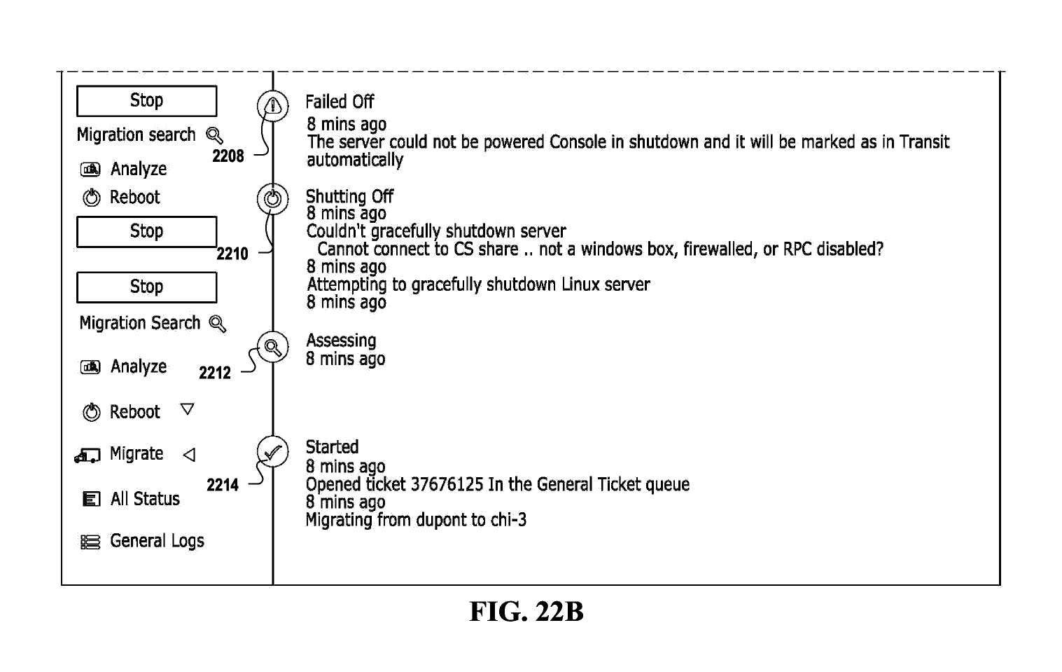

Referring again to FIG. 18, recall that in some embodiments, the system displays the interface as shown in FIG. 18 in response to clicking on the Network Applied meter 1292 described in connection with FIG. 12. Thus, FIG. 18 shows the Networked Applied status interface 1854 for each of the servers having Network Applied status, in this case only one server. Once the system has displayed the interface depicted in FIG. 18, in some embodiments, clicking on the name of a server 1854 may also cause the system to display the interface shown in FIGS. 22A-B, which are depicted on two separate sheets for clarity reasons.

FIGS. 22A-B depict an exemplary interface for displaying a migration log 2200 for the server 1854 described in connection with FIG. 18. Similar to the interface display described in connection with FIGS. 20A-B and FIGS. 21A-B, the interface display for the Network Applied server includes a log of most recent events, including a Network Applied event 2202, a Discovered event 2204, In Transit event 2206, Failed Off event 2208, Shutting Off event 2210, Assessing event 2212, and Started event 2214. Alongside each event, the server displays the information describing the events surrounding the vent as well as what time the events took place, such as information 2216 describing the Network Applied event 2202. As shown in FIGS. 22A-B, the left hand toolbar is also displayed in this embodiment and a similar toolbar may likewise be displayed in any of the aforementioned interfaces.

As will also be apparent to one of skill in the art, many of the interfaces discussed in connection with FIGS. 12-22B form a portion of a set of related screen shots depicting exemplary interfaces for displaying various aspects of the server migration process and taken during a particular points in time throughout the process according to certain embodiments. Thus, each individual interface may be displayed as a result of the system circuitry executing one or more processes, some of which may be initiated manually by a worker and/or may be initiated automatically by the system circuitry itself. By way of illustration, and not limitation, FIGS. 22A-B, for example, show information for the same server 1770 described in connection with FIG. 17, but at later point in time. Specifically, the server 1770 described in connection with FIG. 17 initially had “Discovered” status, and its corresponding migration log at that stage was described in connection with FIGS. 21A-B. However, at a later point in time the server 1770 described in connection with FIG. 17 achieved “Network Applied” status, which was also shown and described as server 1858 described in connection with FIG. 18.

Each and every operation described herein may be implemented by corresponding circuitry. For example, each and every operation may have its own dedicated circuitry, such as may be implemented using a programmable logic array (PLA), application-specific integrated circuit (ASIC), or one or more programmed microprocessors. In some embodiments, each of the operation may be performed by system logic that may include a software controlled microprocessor, discrete logic, such as an ASIC, a programmable/programmed logic device, memory device containing instructions, a combinational logic embodied in hardware, or any combination thereof. Also, logic may also be fully embodied as software, firmware, or hardware. Other embodiments may utilize computer programs, instructions, or software code stored on a non-transitory computer-readable storage medium that runs on one or more processors or system circuitry of one or more distributed servers. Thus, each of the various features of the operations described in connection with the embodiments of FIGS. 1A-22 may be implemented by one or more processors or circuit components of one or more distributed computers or servers that, in conjunction, are configured to execute instructions to perform the function by executing an algorithm in accordance with any steps, flow diagrams, drawings, illustrations, and corresponding description thereof, described herein.

Additionally, each of the aforementioned servers may in fact comprise one or more distributed servers that may be communicatively coupled over a network. Similarly, each of the aforementioned database may form part of the same physical database or server or may consist of one or more distributed databases or servers communicatively coupled over a network, such as the Internet or an intranet. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Numerous modifications will be apparent to those skilled in the art in view of the foregoing description. For example, in any of the preceding embodiments where servers are described, one could substitute a device other than a server, such as a firewall. The tool could also be modified to move unused inventory. Accordingly, this description is to be construed as illustrative only and is presented for the purpose of enabling those skilled in the art to make and use what is herein disclosed and to teach the best mode of carrying out same. The exclusive rights to all modifications which come within the scope of this disclosure are reserved.

We claim:

1. A system stored in a non-transitory medium executable by processor circuitry for tracking the migration of a plurality of servers between data centers, the system comprising:
a job scheduler tool that receives notification of a migrating device that has been disconnected in an origin data center and maintains a list of devices that are in transit from the origin data center to a destination data center;
a migration database that stores migration data for each migrating device, the migration data including information representing a current migration state and past migration states of each migrating device;
one or more processors executing migration logic to identify destination information in the destination data center for each migrating device in the list of devices; and
an analyze tool that checks the current migration state of each migrating device and identifies errors during migration of each migrating device to the destination data center.

2. The system of claim 1, wherein the migration database stores configuration data for each migrating device, and the one or more processors executing migration logic automatically apply the stored configuration data for each migrating device to a corresponding hardware device when the hardware device is installed in the destination data center.

3. The system of claim 1, wherein the job scheduler is configured to monitor and route migration of each migrating device in the list of devices.

4. The system of claim 1, wherein one or more processors executing migration logic further determine a plurality of new destination cabinets in the new data center, cabinet units in the new data center, and switch ports for public and private network interfaces for each migrating device.

5. The system of claim 1, wherein the analyze tool further determines whether the migrating devices are pingable and identifies migrating devices as in transit when the migrating devices are not pingable.

6. The system of claim 1, wherein the analyze tool further determines whether the migrating devices have active switches and switch port information and identifies the migrating devices as discovered devices when the migrating devices have active switches and switch port information.

7. The system of claim 1, further comprising a force discovery tool that causes the system to display a manual input interface, wherein the manual input interface enables a user to manually identify the destination information in the destination data center.

8. The system of claim 1, further comprising a remote shut down tool that shuts down migrating devices before migration from the origin data center to the destination data center.

9. The system of claim 8, wherein the analyze tool further determines whether the migrating devices have properly shut down and identifies migrating devices as failed off when the migrating devices have not properly shut down.

10. The system of claim 1, further comprising a migration logs tool that displays log information for each migration state of each migrating device on a graphical user interface.

11. The system of claim 1, further an assignment tool that assigns any errors identified by the analyze tool to a worker or group of workers.

12. A computer-implemented method for monitoring the migration of a server, comprising:
receiving, by one or more processors, a list of migrating devices that are migrating from an origin data center to a destination data center;
stores, in one or more databases, migration data for each migrating device representing a current migration state and past migration states of each migrating device;
identifying, by the one or more processors, destination information in the destination data center for each migrating device; and
analyzing, by the one or more processors, the current migration state of each migrating device to identify errors during migration of each migrating device to the destination data center.

13. The method of claim 12, further comprising identifying, by the one or more processors, the migrating devices as in transit when the migrating devices are not pingable.

14. The method of claim 12, further comprising identifying, by the one or more processors, the migrating devices as discovered devices when the migrating devices have active switches and switch port information.

15. The method of claim 12, further comprising identifying, by the one or more processors, the migrating devices as network failed when the migrating devices have failed to connect at the destination data center.

16. The method of claim 12, further comprising identifying, by the one or more processors, the migrating devices as failed off when the migrating devices have not properly shut down.

17. The method of claim 12, wherein the one or more database store configuration data for each migrating device, and
wherein the one or more processors automatically apply the stored configuration data for each migrating device to a corresponding hardware device when the hardware device is installed in the destination data center.

18. The method of claim 12, further comprising determining, by the one or more processors, new destination cabinets and cab units in the new data center or switch ports for public and private network interfaces for each migrating device.

19. The method of claim 12, further comprising generating, by the one or more processors, migration logs that display log information for each migration state of each migrating device on a graphical user interface.

20. A system for implementing an interface the migration of a server, comprising:
a means for receiving a list of migrating devices that are migrating from an origin data center to a destination data center;
a means for storing migration data for each migrating device representing a current migration state and past migration states of each migrating device;
a means for identifying destination information in the destination data center for each migrating device; and
a means for analyzing the current migration state of each migrating device to identify errors during migration of each migrating device to the destination of data.
